(19) United States
(12) Patent Application Publication
(10) Pub. No.: US 2023/0422120 A1
(43) Pub. Date: Dec. 28, 2023

(54) CONFIGURATION OF MULTI-TRANSMISSION RECEPTION POINTS FOR INTER-CELL MOBILITY

(71) Applicant: QUALCOMM Incorporated, San Diego, CA (US)

(72) Inventors: Shanyu Zhou, San Diego, CA (US); Jelena DAMNJANOVIC, Dal Mar, CA (US); Tao Luo, San Diego, CA (US)

(21) Appl. No.: 18/212,023

(22) Filed: Jun. 20, 2023

Related U.S. Application Data
(60) Provisional application No. 63/354,897, filed on Jun. 23, 2022.

(51) Int. Cl. H04W 36/08; H04W 36/00

(52) U.S. Cl. CPC H04W 36/08; H04W 36/0064

(57) ABSTRACT

Methods, systems, and devices for wireless communications are described. The method may include a user equipment (UE) receiving first control information indicative of an information element (IE) that includes a set of inter-cell mobility parameters. Moreover, the UE may receive second control information indicative of a change in operating status of a TRP. The change in operating status may include transitioning the TRP to one of a primary TRP or an additional TRP as supported by a corresponding inter-cell mobility parameter of the set of inter-cell mobility parameters. The UE may then communicate with a network entity via the TRP in accordance with the change in operating status.

### CROSS REFERENCE

The present application for patent claims the benefit of U.S. Provisional Patent Application No. 63/354,897 by ZHOU et al., entitled “CONFIGURATION OF MULTI-TRANSMISSION RECEPTION POINTS FOR INTER-CELL MOBILITY,” filed Jun. 23, 2022, assigned to the assignee hereof, and expressly incorporated by reference herein.

### FIELD OF TECHNOLOGY

The following relates to wireless communications, including configuration of multi-transmission reception points (TRPs) for inter-cell mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may communicate with a network entity (e.g., a base station) using a set of transmission reception points (TRPs). In some examples, a TRP of the set of TRPs may act as a primary TRP (e.g., a primary cell) and the remaining TRPs of the set may act as additional TRPs (e.g., secondary cells). Moreover, a subset of the set of cells may be configured for inter-cell mobility. That is, the UE may perform inter-cell mobility operations with the subset of TRPs.

### SUMMARY

The described techniques relate to improved methods, systems, devices, and apparatuses that support configuration of multi-transmission reception points (TRPs) for inter-cell mobility. For example, the described techniques provide for a user equipment (UE) and a network entity changing the operating status of a TRP using layer 1 (L1) signaling or layer 2 (L2) signaling. For example, the UE may receive first control information from the network entity indicating a set of parameters for inter-cell mobility. Additionally, the UE may receive additional control information from the network entity indicating a set of TRPs to apply the set of parameters to (e.g., at least on TRPs configured for inter-cell mobility). The set of parameters may include one or both of a first configuration for transitioning a TRP to a primary TRP (e.g., primary cell configuration) or a second configuration for transitioning a TRP to an additional TRP (e.g., secondary cell configuration). In some examples, the UE may receive second control signaling (e.g., L1/L2 signaling) indicating to change the operating status of a TRP of the set of TRPs. As one example, the TRP may operate as an additional TRP and updating the operating status may include transitioning the TRP to a primary TRP using the first configuration. The UE may then communicate with the network entity via the TRP according to the change in operating status.

A method for wireless communication at a UE is described. The method may include receiving first control information indicative of an information element (IE) that includes a set of inter-cell mobility parameters for communication between the UE and a set of TRPs, receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and communicating with a network entity via the TRP in accordance with the change in operating status.

An apparatus for wireless communication at a UE is described. The apparatus may include a processor, memory coupled with the processor, and instructions stored in the memory. The instructions may be executable by the processor to cause the apparatus to receive first control information indicative of an IE that includes a set of inter-cell mobility parameters for communication between the UE and a set of TRPs, receive second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and communicate with a network entity via the TRP in accordance with the change in operating status.

Another apparatus for wireless communication at a UE is described. The apparatus may include means for receiving first control information indicative of an IE that includes a set of inter-cell mobility parameters for communication between the UE and a set of TRPs, means for receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and means for communicating with a network entity via the TRP in accordance with the change in operating status.

A non-transitory computer-readable medium storing code for wireless communication at a UE is described. The code may include instructions executable by a processor to receive first control information indicative of an IE that includes a set of inter-cell mobility parameters for communication between the UE and a set of TRPs, receive second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and communicate with a network entity via the TRP in accordance with the change in operating status.

Some examples of the method, apparatuses, and non-transitory computer-readable medium described herein may further include operations, features, means, or instructions for receiving additional control information indicative of the set of TRPs to which the set of inter-cell mobility parameters may be applicable.

Some examples of the method, apparatuses, and non-transitory computer-readable medium described herein may further include operations, features, means, or instructions for receiving additional control information indicative of one or more TRPs of the set of TRPs to which the set of inter-cell mobility parameters may be no longer applicable.

In some examples of the method, apparatuses, and non-transitory computer-readable medium described herein, the additional control information includes a set of bits, each bit of the set of bits corresponds to a respective TRP of a set of multiple TRPs included in a serving cell of the network entity, and a logic value of the each bit of the set of bits may be indicative of whether the set of inter-cell mobility parameters may be no longer applicable to the respective TRP.

In some examples of the method, apparatuses, and non-transitory computer-readable medium described herein, the additional control information includes a set of bits, each bit of the set of bits corresponds to a respective TRP of the set of TRPs, and a logic value of the each bit of the set of bits may be indicative of whether the set of inter-cell mobility parameters may be no longer applicable to the respective TRP.

Some examples of the method, apparatuses, and non-transitory computer-readable medium described herein may further include operations, features, means, or instructions for removing the one or more TRPs from the set of TRPs based on receiving the additional control information.

Some examples of the method, apparatuses, and non-transitory computer-readable medium described herein may further include operations, features, means, or instructions for communicating, prior to receiving the second control information, with the network entity via the TRP, where the TRP may be operating, prior to receiving the second control information, as the additional TRP.

In some examples of the method, apparatuses, and non-transitory computer-readable medium described herein, the corresponding inter-cell mobility parameter includes only a first configuration for the TRP to communicate with the network entity while operating as the primary TRP or both the first configuration and a second configuration for the TRP to communicate with the network entity while operating as the primary TRP or as the additional TRP, respectively.

Some examples of the method, apparatuses, and non-transitory computer-readable medium described herein may further include operations, features, means, or instructions for switching from communicating with the network entity via the TRP while the TRP may be operating as the additional TRP to communicating with the network entity via the TRP while the TRP may be operating as the primary TRP based on receiving the second control information and applying a first configuration which may be for the TRP to communicate with the network entity while operating as the primary TRP.

In some examples of the method, apparatuses, and non-transitory computer-readable medium described herein, the set of inter-cell mobility parameters includes both the first configuration and a second configuration which may be for the TRP to communicate with the network entity while operating as the additional TRP and the method, apparatuses, and non-transitory computer-readable medium may include further operations, features, means, or instructions for switching from communicating with the network entity via the TRP while the TRP may be operating as the primary TRP to communicating with the network entity via the TRP while the TRP may be operating as the additional TRP based on applying the second configuration.

Some examples of the method, apparatuses, and non-transitory computer-readable medium described herein may further include operations, features, means, or instructions for communicating, prior to receiving the second control information, with the network entity via the TRP, where the TRP may be operating, prior to receiving the second control information, as the primary TRP.

In some examples of the method, apparatuses, and non-transitory computer-readable medium described herein, the corresponding inter-cell mobility parameter includes only a second configuration for the TRP to communicate with the network entity while operating as the additional TRP or both the second configuration and a first configuration for the TRP to communicate with the network entity while operating as the additional TRP or as the primary TRP, respectively.

Some examples of the method, apparatuses, and non-transitory computer-readable medium described herein may further include operations, features, means, or instructions for switching from communicating with the network entity via the TRP while the TRP may be operating as the primary TRP to communicating with the network entity via the TRP while the TRP may be operating as the additional TRP based on receiving the second control information and applying a second configuration which may be for the TRP to communicate with the network entity while operating as the additional TRP.

In some examples of the method, apparatuses, and non-transitory computer-readable medium described herein, the set of inter-cell mobility parameters includes both the second configuration and a first configuration which may be for the TRP to communicate with the network entity while operating as the primary TRP and the method, apparatuses, and non-transitory computer-readable medium may include further operations, features, means, or instructions for switching from communicating with the network entity via the TRP while the TRP may be operating as the additional TRP to communicating with the network entity via the TRP while the TRP may be operating as the primary TRP based on applying the first configuration.

In some examples of the method, apparatuses, and non-transitory computer-readable medium described herein, receiving the first control information may include operations, features, means, or instructions for receiving radio resource control (RRC) signaling that includes the first control information.

In some examples of the method, apparatuses, and non-transitory computer-readable medium described herein, receiving the second control information may include operations, features, means, or instructions for receiving L1 signaling or L2 signaling that includes the second control information.

A method for wireless communication at a network entity is described. The method may include transmitting first control information indicative of an IE that includes a set of inter-cell mobility parameters for communication between a UE and a set of TRPs, transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and communicating with the UE via the TRP in accordance with the change in operating status.

An apparatus for wireless communication at a network entity is described. The apparatus may include a processor, memory coupled with the processor, and instructions stored in the memory. The instructions may be executable by the processor to cause the apparatus to transmit first control information indicative of an IE that includes a set of inter-cell mobility parameters for communication between a UE and a set of TRPs, transmit second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and communicate with the UE via the TRP in accordance with the change in operating status.

Another apparatus for wireless communication at a network entity is described. The apparatus may include means for transmitting first control information indicative of an IE that includes a set of inter-cell mobility parameters for communication between a UE and a set of TRPs, means for transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and means for communicating with the UE via the TRP in accordance with the change in operating status.

A non-transitory computer-readable medium storing code for wireless communication at a network entity is described. The code may include instructions executable by a processor to transmit first control information indicative of an IE that includes a set of inter-cell mobility parameters for communication between a UE and a set of TRPs, transmit second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters, and communicate with the UE via the TRP in accordance with the change in operating status.

Some examples of the method, apparatuses, and non-transitory computer-readable medium described herein may further include operations, features, means, or instructions for transmitting additional control information indicative of the set of TRPs to which the set inter-cell mobility parameters may be applicable.

Some examples of the method, apparatuses, and non-transitory computer-readable medium described herein may further include operations, features, means, or instructions for transmitting additional control information indicative of one or more TRPs of the set of TRPs to which the set of inter-cell mobility parameters may be no longer applicable.

In some examples of the method, apparatuses, and non-transitory computer-readable medium described herein, the additional control information includes a set of bits, each bit of the set of bits corresponds to a respective TRP of a set of multiple TRPs included in a serving cell of the network entity, and a logic value of the each bit of the set of bits may be indicative of whether the set of inter-cell mobility parameters may be no longer applicable to the respective TRP.

In some examples of the method, apparatuses, and non-transitory computer-readable medium described herein, the additional control information includes a set of bits, each bit of the set of bits corresponds to a respective TRP of the set of TRPs, and a logic value of the each bit of the set of bits may be indicative of whether the set of inter-cell mobility parameters may be no longer applicable to the respective TRP.

Some examples of the method, apparatuses, and non-transitory computer-readable medium described herein may further include operations, features, means, or instructions for communicating, prior to transmitting the second control information, with the UE via the TRP, where the TRP may be operating, prior to transmitting the second control information, as the additional TRP.

In some examples of the method, apparatuses, and non-transitory computer-readable medium described herein, the corresponding inter-cell mobility parameter includes only a first configuration for the TRP to communicate with the UE while operating as the primary TRP or both the first configuration and a second configuration for the TRP to communicate with the UE while operating as the primary TRP or as the additional TRP, respectively.

Some examples of the method, apparatuses, and non-transitory computer-readable medium described herein may further include operations, features, means, or instructions for switching from communicating with the UE via the TRP while the TRP may be operating as the additional TRP to communicating with UE via the TRP while the TRP may be operating as the primary TRP based on transmitting the second control information and applying a first configuration which may be for the TRP to communicate with the UE while operating as the primary TRP.

In some examples of the method, apparatuses, and non-transitory computer-readable medium described herein, the set of inter-cell mobility parameters includes both the first configuration and a second configuration which may be for the TRP to communicate with the UE while operating as the additional TRP and the method, apparatuses, and non-transitory computer-readable medium may include further operations, features, means, or instructions for switching from communicating with the UE via the TRP while the TRP may be operating as the primary TRP to communicating with the UE via the TRP while the TRP may be operating as the additional TRP based on applying the second configuration.

Some examples of the method, apparatuses, and non-transitory computer-readable medium described herein may further include operations, features, means, or instructions for communicating, prior to transmitting the second control information, with the UE via the TRP, where the TRP may be operating, prior to transmitting the second control information, as the primary TRP.

In some examples of the method, apparatuses, and non-transitory computer-readable medium described herein, the corresponding inter-cell mobility parameter includes only a second configuration for the TRP to communicate with the UE while operating as the additional TRP or both the second configuration and a first configuration for the TRP to communicate with the UE while operating as the additional TRP or as the primary TRP, respectively.

Some examples of the method, apparatuses, and non-transitory computer-readable medium described herein may further include operations, features, means, or instructions for switching from communicating with the UE via the TRP while the TRP may be operating as the primary TRP to communicating with the UE via the TRP while the TRP may be operating as the additional TRP based on transmitting the second control information and applying a second configuration which may be for the TRP to communicate with the UE while operating as the additional TRP.

In some examples of the method, apparatuses, and non-transitory computer-readable medium described herein, the set of inter-cell mobility parameters includes both the second configuration and a first configuration which may be for the TRP to communicate with the UE while operating as the primary TRP and the method, apparatuses, and non-transitory computer-readable medium may include further operations, features, means, or instructions for switching from communicating with the UE via the TRP while the TRP may be operating as the additional TRP to communicating with the UE via the TRP while the TRP may be operating as the primary TRP based on applying the first configuration.

In some examples of the method, apparatuses, and non-transitory computer-readable medium described herein, transmitting the first control information may include operations, features, means, or instructions for transmitting RRC signaling that includes the first control information.

In some examples of the method, apparatuses, and non-transitory computer-readable medium described herein, transmitting the second control information may include operations, features, means, or instructions for transmitting L1 signaling or L2 signaling that includes the second control information.

### BRIEF DESCRIPTION OF THE DRAWINGS

FIG. 1 illustrates an example of a wireless communications system that supports configuration of multi-transmission reception points (TRPs) for inter-cell mobility in accordance with one or more aspects of the present disclosure.

FIG. 2 illustrates an example of a network architecture that supports configuration of multi-TRPs for inter-cell mobility in accordance with one or more aspects of the present disclosure.

FIG. 3 illustrates an example of a wireless communications system that supports configuration of multi-TRPs for inter-cell mobility in accordance with one or more aspects of the present disclosure.

FIG. 4 illustrates an example of a release scheme that supports configuration of multi-TRPs for inter-cell mobility in accordance with one or more aspects of the present disclosure.

FIG. 5 illustrates an example of a process flow that supports configuration of multi-TRPs for inter-cell mobility in accordance with one or more aspects of the present disclosure.

FIGS. 6 and 7 show block diagrams of devices that support configuration of multi-TRPs for inter-cell mobility in accordance with one or more aspects of the present disclosure.

FIG. 8 shows a block diagram of a communications manager that supports configuration of multi-TRPs for inter-cell mobility in accordance with one or more aspects of the present disclosure.

FIG. 9 shows a diagram of a system including a device that supports configuration of multi-TRPs for inter-cell mobility in accordance with one or more aspects of the present disclosure.

FIGS. 10 and 11 show block diagrams of devices that support configuration of multi-TRPs for inter-cell mobility in accordance with one or more aspects of the present disclosure.

FIG. 12 shows a block diagram of a communications manager that supports configuration of multi-TRPs for inter-cell mobility in accordance with one or more aspects of the present disclosure.

FIG. 13 shows a diagram of a system including a device that supports configuration of multi-TRPs for inter-cell mobility in accordance with one or more aspects of the present disclosure.

FIGS. 14 through 19 show flowcharts illustrating methods that support configuration of multi-TRPs for inter-cell mobility in accordance with one or more aspects of the present disclosure.

### DETAILED DESCRIPTION

In some examples, a network entity (e.g., a base station) may communicate with a user equipment (UE) using a set of transmission reception points (TRPs). In some examples, the set of TRPs may include at least one primary TRP and one or more additional TRPs. As the UE moves throughout a coverage area of the network entity, the UE may move out of coverage of a primary TRP and into coverage of an additional TRP and as such, the primary TRP may be switched to be an additional TRP and the additional TRP may be switched to be a primary TRP. In order to perform the switching, the UE may perform a handover. That is, the primary TRP may be changed using layer 3 (L3) signaling which may incur more latency when compared to other types of signaling (e.g., layer 1 (L1) signaling or layer 2 (L2) signaling).

In some examples, the primary TRP may be changed using L1 or L2 signaling. In one example, the UE may receive signaling indicating one or more parameters for inter-cell mobility. The one or more parameters may include one or both of a primary cell configuration or a secondary cell configuration. Additionally, the signaling may include an indication of a subset of the set of TRPs to apply the one or more parameters to. In some examples, the UE may receive second control signaling (e.g., L1 signaling or L2 signaling) activating or changing the operating status of a TRP. As one example, the TRP may include a primary TRP and updating the activation state may include updating the TRP from a primary TRP to an additional TRP. In such example, the UE may use the secondary cell configuration included in the signaling to make the switch. In some examples, at a later time, the TRP may receive third signaling releasing the TRP. That is, the one or more parameters may no longer apply to the TRP. By allowing for primary TRP switching by L1 signaling or L2 signaling, as opposed to L3 signaling, latency may be reduced.

Aspects of the disclosure are initially described in the context of wireless communications systems. Additional aspects are described in the context of a removal scheme or a process flow. Aspects of the disclosure are further illustrated by and described with reference to apparatus diagrams, system diagrams, and flowcharts that relate to configuration of multi-TRPs for inter-cell mobility.

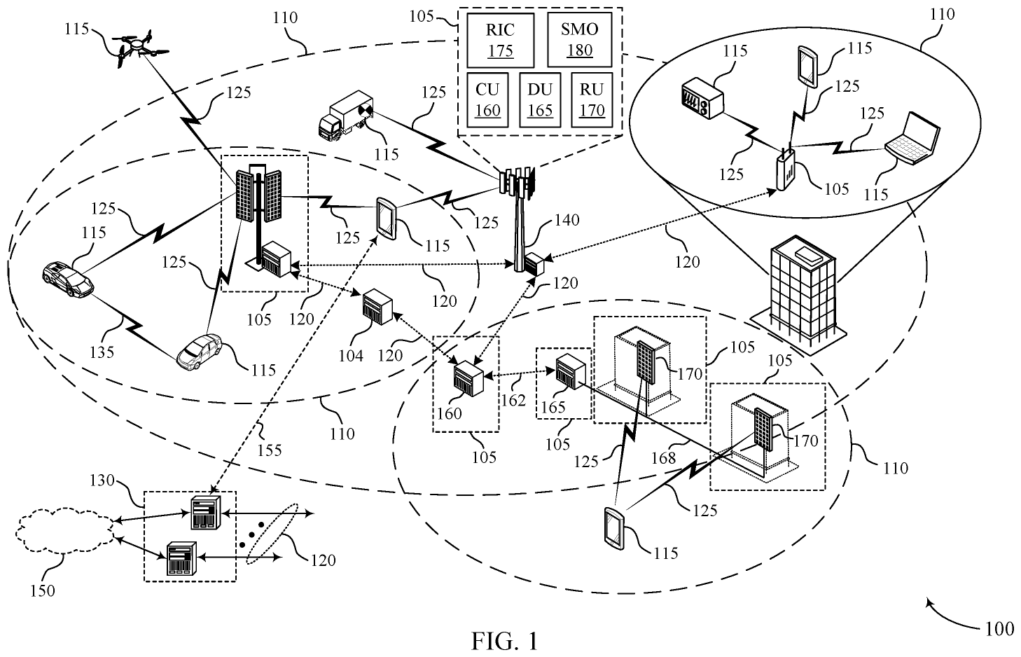

FIG. 1 illustrates an example of a wireless communications system 100 that supports configuration of multi-TRPs for inter-cell mobility in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), L2) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as L1 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support configuration of multi-TRPs for inter-cell mobility as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCI), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a UE 115 and a network entity 105 may change the operating status of a TRP using L1 signaling or L2 signaling. For example, the UE 115 may receive first control information from the network entity 105 indicating a set of parameters for inter-cell mobility. Additionally, the UE 115 may receive additional control information from the network entity 105 indicating a set of TRPs to apply the set of parameters to (e.g., at least on TRP configured for inter-cell mobility). The set of parameters may include one or both of a first configuration for transitioning a TRP to a primary TRP (e.g., primary cell configuration) or a second configuration for transitioning a TRP to an additional TRP (e.g., secondary cell configuration). In some examples, the UE 115 may receive second control signaling (e.g., L1/L2 signaling) indicating to change the operating status of a TRP of the set of TRPs. As one example, the TRP may operate as an additional TRP and updating the operating status may include transitioning the TRP to a primary TRP using the first configuration. The UE 115 may then communicate with the network entity 105 via the TRP according to the change in operating status.

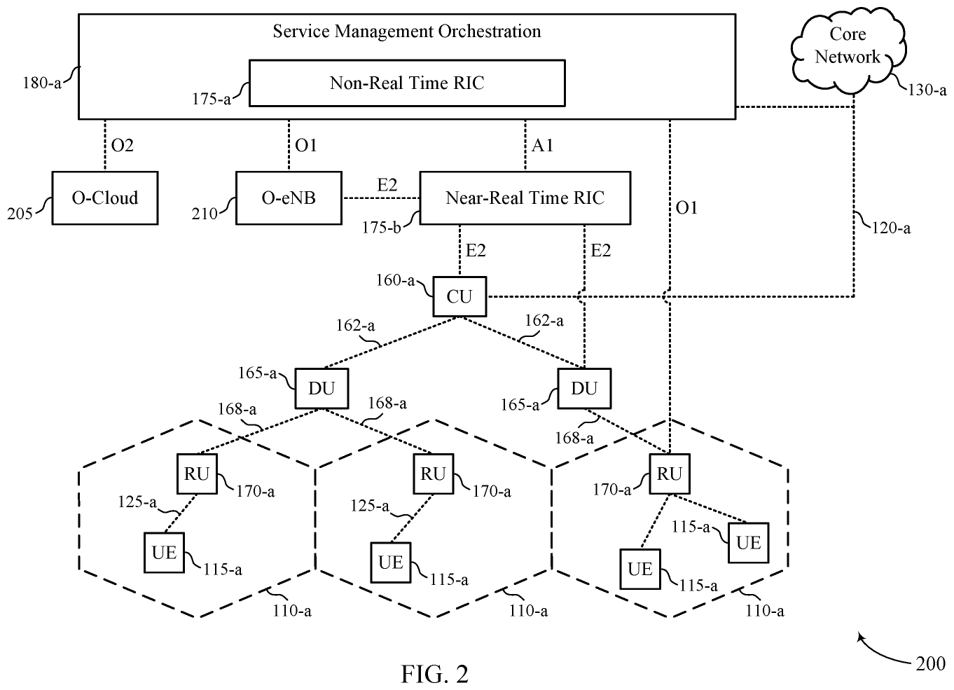

FIG. 2 illustrates an example of a network architecture 200 (e.g., a disaggregated base station architecture, a disaggregated RAN architecture) that supports configuration of multi-TRPs for inter-cell mobility in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

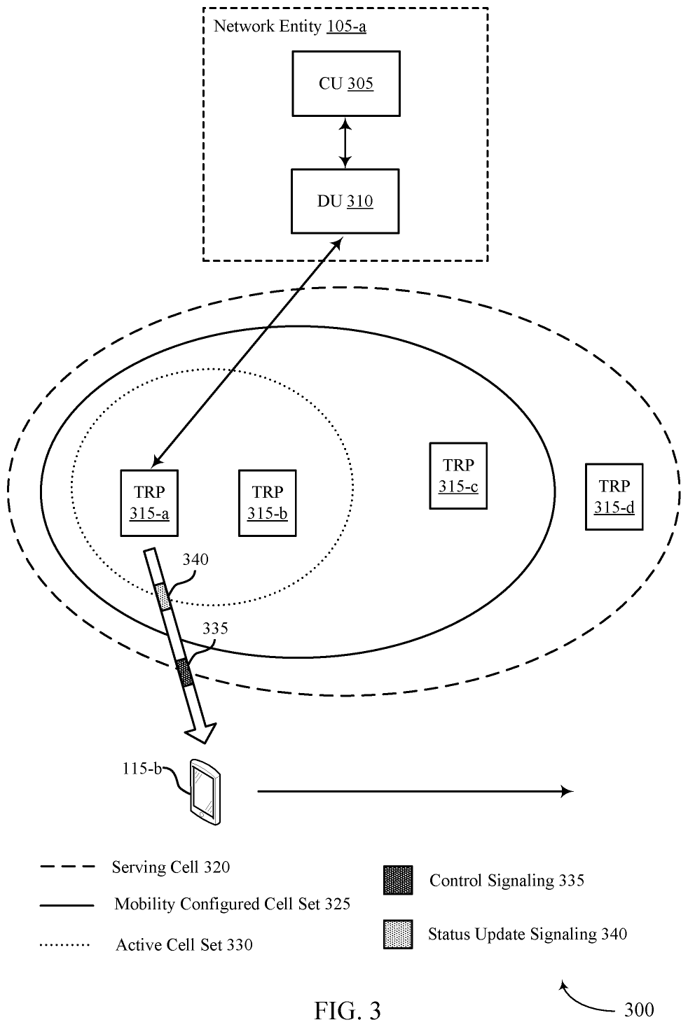

FIG. 3 illustrates an example of a wireless communications system 300 that supports configuration of multi-TRPs for inter-cell mobility in accordance with one or more aspects of the present disclosure. In some examples, the wireless communications system 300 may include aspects of a wireless communications system 100 and a network architecture 200. For example, the wireless communications system 300 may include a network entity 105-a and a UE 115-b which may be an example of a network entity 105 and a UE 115 as described in FIG. 1. Moreover, the network entity 105-a may include a CU 305 and a DU 310 which may be examples of a CU 160 and a DU 165 as described in FIGS. 1 and 2.

In some examples, the wireless communications system 300 may support a disaggregated RAN architecture. As described in FIGS. 1 and 2, in a disaggregated RAN architecture, functionality of the network entity 105-a may be split between a CU 305, a DU 310, and one or more RUs. The CU 305 may host upper protocol layers (e.g., L3 and L2 functionality and signaling), whereas the DU 310 and the one or more RUs may host lower protocol layers (e.g., L1 and L2 functionality and signaling). An example of L3 signaling may be RRC signaling, an example of L2 signaling may be RLC signaling, and an example of L1 signaling may be PHY layer signaling. The CU 305, the DU 310, and the RU may communicate with one another. For example, the CU 305 may communicate with the DU 310 via a midhaul communication link and the DU 310 may communicate with the RU via a fronthaul communication link.

In some examples, the network entity 105-a may communicate with the UE 115-b via a set of TRPs 315 (e.g., a TRP 315-a, a TRP 315-b, a TRP 315-c, and a TRP 315-d). The TRPs 315 may be examples of RUs and may be located in a serving cell 320 of the network entity 105-a. Further, the wireless communications system 300 may support inter-cell mobility. That is, the wireless communications system 300 may support making changes to the TRPs 315 as the UE 115-b moves throughout the serving cell 320. To support inter-cell mobility, the UE 115-b may receive RRC signaling from the network entity 105-a indicating a subset of TRPs 315 of the set of TRPs 315 that are configured for inter-cell mobility. As one example, the TRP 315-a, the TRP 315-b, and the TRP 315-c may be included in a mobility configured cell set 325.

Within the mobility configured cell set 325, there may be an activated cell set 330 and a deactivated cell set. The TRPs 315 included in the activated cell set 330 are activated and can be readily used for data and control transfer. The TRPs 315 included in the deactivated cell set are deactivated and cannot be readily used for data and control transfer. As shown in FIG. 3, the activated cell set 330 may include the TRP 315-a and the TRP 315-b and the deactivated cell set may include the TRP 315-c. As the UE 115-b moves, the TRPs 315 within the mobility configured cell set 325 may be activated or deactivated by L1 or L2 signaling (e.g., based on signal quality measurements). As illustrated in FIG. 3, the UE 115-b may move from left to right. This movement may result in the UE 115-b moving out of the coverage area of the activated cell set 330 and into the coverage area of the deactivated cell set. As such, the network entity 105-a may signal (e.g., L1 signaling or L2 signaling) to the UE 115-b to activate the TRP 315-c and potentially deactivate one or both of the TRP 315-a and the TRP 315-b.

In some examples, the TRPs 315 included in the serving cell 320 may be of different types. For example, one of the TRP 315 of the set may be known as the primary TRP and the remaining TRPs 315 of the set may be known as additional TRPs. In the case that there is no carrier aggregation, each TRP of the set may support one CC and the CC for each TRP may be the same. Additionally, if there is no carrier aggregation, the primary TRP may operate as a primary cell and the additional TRPs may operate as secondary cells. The TRP 315 that operates as a primary cell may perform initial establishment procedures or initiate re-establishment procedures and the TRPs 315 that operate as secondary cells may provide support to the TRP 315 that operates as the primary cell (e.g., provide additional resources). In the example of FIG. 3, the TRP 315-a may initially operate as the primary cell and the TRP 315-b, the TRP 315-c, and the TRP 315-c may initially operate as secondary cells.

In addition to activating or deactivating the TRPs 315 within the mobility configured cell set 325, the UE 115-b and the network entity 105-a may change the operating status of TRPs 315. That is, the UE 115-b and the network entity 105-a may update a primary TRP to be an additional TRP or an additional TRP to be a primary TRP. But in order to change the operational status of a TRP 315 (e.g., change a TRP 315 from an additional TRP to a primary TRP), the UE 115-b may perform a handover procedure with the network entity 105-a, where the handover procedure may involve L3 signaling between the UE 115-b and the network entity 105-a. As compared to other signaling (e.g., L1 and L2 signaling), L3 signaling may result in more latency and as such, using L3 for inter-cell mobility may be inefficient.

As described herein, the wireless communications system 300 may utilize L1 or L2 signaling to change the operating status of TRPs 315 configured for inter-cell mobility. As shown in FIG. 3, the TRP 315-a, the TRP 315-b, the TRP 315-c, and the TRP 315-d may be included in the serving cell 320 of the network entity 105-a. Additionally, the TRP 315-a, the TRP 315-b, and the TRP 315-c may be included in the mobility configured cell set 325 and more specifically, the TRP 315-a and the TRP 315-b may be included in the activated cell set 330 and the TRP 315-c may be included in the deactivated cell set. Moreover, the TRP 315-a may initially operate as a primary TRP (e.g., a primary cell) and the TRP 315-b, the TRP 315-c, and the TRP 315-d may operate as additional TRPs (e.g., a secondary cells).

In some examples of the methods as described herein, the UE 115-b may receive control signaling 335 (e.g., RRC signaling) from the network entity 105-a indicating a set of parameters for inter-cell mobility. As one example, the set of parameters may include one or both of a primary cell configuration (e.g., spCellConfig) or a secondary cell configuration (e.g., sCellConfig). Additionally, the control signaling 335 may indicate a set of TRPs 315 that the set of parameters is applicable to. For example, the control signaling may include a list of PCIs, where each PCI of the list of PCIs indicates a TRP 315 that the set of parameters apply to. The list may include all TRPs 315 within the mobility configured cell set 325 or a portion of the TRPs 315 included in the mobility configured cell set 325. If the control signaling 335 does not include the list of applicable TRPs 315, the UE 115-b may apply the set of parameters to all TRPs 315 of the mobility configured cell set 325 (e.g., non-TRP specific). In some examples, the UE 115-b may receive the control signaling 335 from the network entity 105-a via a primary TRP. For example, as shown in FIG. 3, the UE 115-b may receive the control signaling 335 from the network entity 105-a via the TRP 315-a. In some examples, the set of parameters and potentially the set of TRPs 315 that the set of parameters is applicable to may be indicated in a serving cell configuration in an RRC message. For example, a first information element (IE) (e.g., L1L2MobilityConfig) may be included in the serving cell configuration IE (e.g., ServingCellConfig) to indicate the set of parameters. Additionally, a second IE (e.g., additionalPCIToAdolModL1L2MobilityConfigList) may be included in the serving cell configuration IE (e.g., ServingCellConfig) to indicate the set of TRPs 315 to apply the set of parameters to.

In one example, the set of parameters included in the control signaling 335 may include both the primary cell configuration and the secondary cell configuration. In such example, the UE 115-b may have the ability to update an additional TRP to be a primary TRP using the primary cell configuration and update a primary TRP to be an additional TRP using the secondary cell configuration. In the example of FIG. 3, the TRP 315-a may initially be a primary TRP and the TRP 315-b, the TRP 315-c, and the TRP 315-d may initially be additional TRPs. As such, the UE 115-b may have an initial primary cell configuration for the TRP 315-a (e.g., different from the primary cell configuration provided in the control signaling 335) and an initial secondary cell configuration for the TRP 315-b, the TRP 315-c, and the TRP 315-d (e.g., different from the secondary cell configuration provided in the control signaling 335).

In some examples, the UE 115-b may change locations. For example, as illustrated in FIG. 3, the UE 115-b may travel from left to right. Moving from left to right may cause the UE 115-b to lose service or have poor service with the TRP 315-a and gain service or have strong service with the TRP 315-b. That is, a signal strength measurement associated with the TRP 315-b may be higher than a signal strength measurement associated with the TRP 315-a as the UE 115-b moves from left to right. In response to this change of location of the UE 115-b, the network entity 105-a may transmit status update signaling 340 (e.g., L1 signaling or L2 signaling) indicating to update the operating status of the TRP 315-b from an additional TRP to a primary TRP. Updating the TRP 315-b from an additional TRP to a primary TRP may include the UE 115-b applying the primary cell configuration included in the control signaling 335 such that the UE 115-b may communicate with the network entity 105-a via the TRP 315-b operating as a primary cell. In addition, the status update signaling 340 may potentially include an indication to update the TRP 315-a from a primary TRP to an additional TRP. Updating the TRP 315-a from a primary TRP to an additional TRP may include the UE 115-b applying the secondary cell configuration included in the control signaling 335 such that the UE 115-b may communicate with the network entity 105-a via the TRP 315-a operating as a secondary cell.

In some examples, at a later time, the UE 115-b may receive second status update signaling indicating to update the operating status of TRP 315-b from a primary TRP back to an additional TRP. Such scenario may occur if the UE 115-b changes location which results in poor service with the TRP 315-b. For example, as shown in FIG. 3, the UE 115-b may continue to travel to the right. To update the TRP 315-b from a primary TRP back to an additional TRP, the UE 115-b may apply either the initial secondary cell configuration or the secondary cell configuration included in the control signaling 335.

In another example, the set of parameters included in the control signaling 335 may depend on the serving cell 320. For example, if the serving cell 320 is a primary cell, the set of parameters may include the secondary cell configuration and may not include the primary cell configuration. Alternatively, if the serving cell 320 is a secondary cell, the set of parameters may include the primary cell configuration and may not include a secondary cell configuration.

In some examples, the network entity 105-a may remove one or more TRPs 315 from the mobility configured cell set 325. The network entity 105-a may remove a TRP 315 from the mobility configured cell set 325 if the UE 115-b moves out of the range or coverage of the TRP 315 and it is not expected that the UE 115-b will move back into the range or coverage of the TRP 315. As one example, the network entity 105-a may determine to remove the TRP 315-a from the mobility configured cell set 325. In such example, the network entity 105-a may transmit removal signaling indicating to release the TRP 315-a from the mobility configured cell set 325. In some examples, the TRP 315 to be released may be indicated via RRC signaling. As one example, the serving cell configuration in RRC may include an IE (e.g., additionalPCIIndex-r17) that lists all of the TRPs 315 of the serving cell 320 (e.g., list of PCIs) and when one or more TRPs 315 of the mobility configured cell set 325 are to be released, the network entity 105-a may transmit RRC signaling indicating which TRPs 315 of the list are to be released (e.g., additionalPCItoReleaseL1L2MobilityConfigList). In another example, an IE (e.g., additionalPCIL1L2MobilityIndex) may be included in the serving cell configuration in RRC that lists all of the TRPs 315 of the mobility configured cell set 325 (e.g., list of PCIs) and when one or more TRPs 315 of the mobility configured cell set 325 are to be released, the network entity 105-a may transmit RRC signaling indicating which TRPs 315 of the list are to be released (e.g., additionalP CItoReleaseL1L2MobilityConfigList).

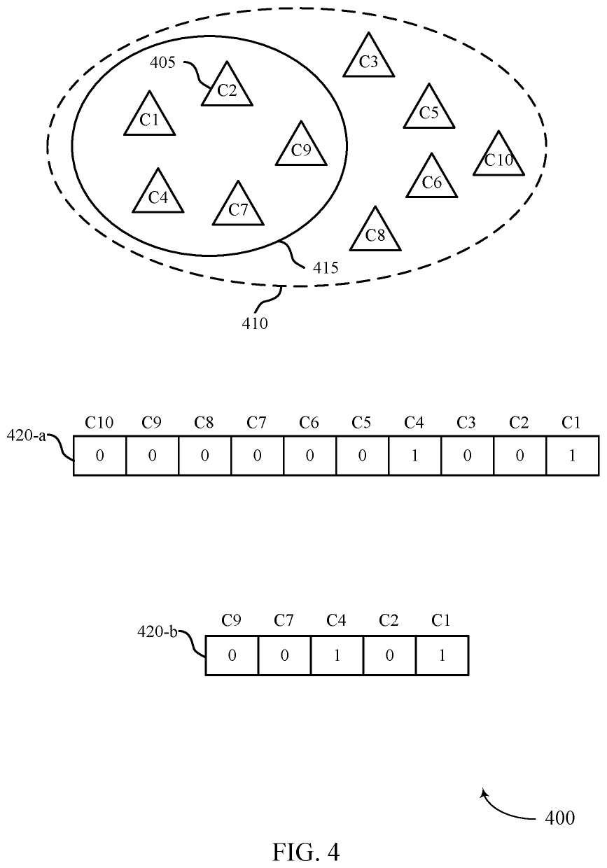

FIG. 4 illustrates an example of a release scheme 400 that supports configuration of multi-TRPs for inter-cell mobility in accordance with one or more aspects of the present disclosure. In some examples, the release scheme 400 may include aspects of a wireless communications system 100, a network architecture 200, and a wireless communications system 300. For example, the release scheme 400 may include a serving cell 410, a mobility configured cell set 415, and cells 405 which may be examples of a serving cell 320, a mobility configured cell set 325, and TRP 315 as described with reference to FIG. 3, respectively.

In some examples, a network entity may transmit first control signaling (e.g., RRC message) to a UE indicating a configuration for a serving cell 410 of the network entity. In some examples, the configuration may specify an index for cells 405 included in the serving cell 410. For example, the configuration may include a serving cell index list, and each index of the serving cell index list corresponds to one of C1, C2, C3, C4, C5, C6, C7, C8, C9, and C10. As an example, the first index in the serving cell index may correspond to C1 and the last index in the serving cell index may correspond to C10. Moreover, some of the cells 405 in the serving cell 410 may be configured for inter-cell mobility. For example, the mobility configured cell set 415 of the serving cell 410 may include C1, C2, C4, C7, and C9. As the UE moves about the serving cell 410, the cells 405 configured for inter-cell mobility may be removed from the mobility configured cell set 415.

To remove the one or more cells 405, the network entity may transmit second control signaling (e.g., an RRC reconfiguration message) indicating which cells 405 to remove. In one example, the second control signaling may include a sequence of bits 420-a that corresponds directly to the serving cell index list. That is, a 4th bit in the sequence of bits 420-a may correspond to the fourth indexed cell 405 (e.g., C4). The sequence of bits 420-a may have a logic value of 1 or 0. A 0 may indicate to keep the associated cell 405 in the mobility configured cell set 415 and a 1 may indicate to remove the cell 405 from the mobility configured cell set 415. As an example, the network entity may determine to remove C4 and C1 from the mobility configured cell set 415. In such example, the network entity may transmit the sequence of bits 420-a where the fourth bit and the first bit have a logic value of 1 and the remaining bits have a logic value of 0 (e.g., 1001000000).

In another example, the configuration may specify an index for cells 405 included in the mobility configured cell set 415. For example, the configuration may include a mobility configured index list, and each index of the mobility configured index list corresponds to one of C1, C2, C4, C7, and C9. As an example, the first index in the serving cell index may correspond to C1 and the last index serving cell index may correspond to C9. In such example, to remove the one or more cells 405, the network entity may transmit second control signaling (e.g., an RRC reconfiguration message) indicating which cells 405 to remove. In one example, the second control signaling may include a sequence of bits 420-b that corresponds directly to the mobility configured index list. That is, a 4th bit in the sequence of bits 420-b may correspond to the fourth indexed cell 405 (e.g., C7). The sequence of bits 420-b may have a logic value of 1 or 0. A 0 may indicate to keep the associated cell 405 in the mobility configured cell set 415 and a 1 may indicate to remove the cell 405 from the mobility configured cell set 415. As an example, the network entity may determine to remove C4 and C1 from the mobility configured cell set 415. In such example, the network entity may transmit the sequence of bits 420-b where the third bit and the first bit have a logic value of 1 and the remaining bits have a logic value of 0 (e.g., 10100).

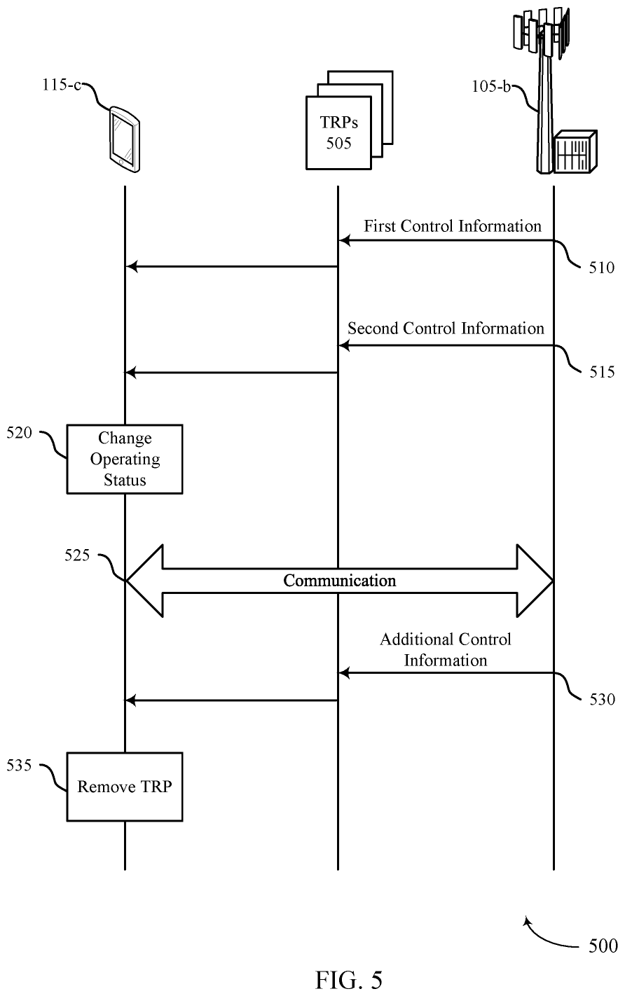

FIG. 5 illustrates an example of a process flow 500 that supports configuration of multi-TRPs for inter-cell mobility in accordance with one or more aspects of the present disclosure. In some examples, the process flow 500 may be implemented by aspects of a wireless communications system, a network architecture 200, a wireless communications system 300, and a release scheme 400. For example, the process flow 500 may be implemented by a UE 115-c and a network entity 105-b which may be examples of a UE 115 and a network entity 105 as described with reference to FIGS. 1-4. Alternative examples of the following may be implemented, where some steps are performed in a different order than described or are not performed at all.

At 510, the UE 115-c may receive first control information from the network entity 105-b. In some examples, the network entity 105-b may communicate with the UE 115-c via a set of TRPs 505. The set of TRPs 505 may include a primary TRP and one or more additional TRPs. Moreover, a subset of the set of TRPs 505 may be configured for inter-cell mobility. In some examples, the UE 115-c may receive the first control information from the network entity 105-b via the primary TRP of the set of TRPs 505. The first control information may be indicative of an IE that includes a set of inter-cell mobility parameters for at least one TRP 505 of the subset of TRPs 505. Each parameter of the set of parameters may correspond to the at least one TRP 505 and each inter-cell mobility parameter may be associated with communication between the UE 115-c and the at least one corresponding TRP 505 In some examples, the UE 115-c may receive additional control information that may be indicative of an IE that includes an indication of the at least one TRP 505 that the inter-cell parameters may be applicable to. The first control information may be included in RRC signaling or L3 signaling.

In some examples, the set of parameters may include both a first configuration and a second configuration. The first configuration may be for a TRP 505 to communicate with the network entity 105-b as a primary TRP or the second configuration may be for a TRP 505 to communicate with the network entity 105-b as an additional TRP. In some examples, the set of parameters included in the first control information may be dependent on a type of serving cell. For example, if the serving cell that includes the TRPs 505 is a primary cell, the set of parameters may include the second configuration and may not include the first configuration. The UE 115-c may already have knowledge of the first configuration due to the serving cell being a primary cell. Alternatively, if the serving cell that includes the TRPs 505 is a secondary cell, the set of parameters may include the primary configuration and may not include the second configuration. The UE 115-c may already have knowledge of the second configuration due to the serving cell being a secondary cell.

At 515, the UE 115-c may receive second control information indicating a change in the operating status of a TRP 505 of the subset of TRPs 505 and change the operating status of the TRP 505 based on the second control information at 520. A change in operating status may include transitioning the TRP 505 to one of a primary TRP or a secondary TRP. As one example, the TRP 505 may operate as a primary TRP and receive the second control information indicating a change in the operating status of the TRP 505. Upon receiving the second control information, the UE 115-c may transition the TRP 505 from a primary TRP to an additional TRP using the second configuration indicated in the first control information at 520. In some examples, at a later time, the UE 115-c may transition the TRP 505 from an additional TRP back to a primary TRP using the first configuration indicated in the first control information (e.g., if the first control information includes both the first configuration and the second configuration). The second control information may be included in L1 signaling or L2 signaling.

At 525, the UE 115-c may communicate with the network entity 105-b via the TRP 505 in accordance to the change in operating status. As described above, the TRP 505 may operate as an additional TRP after receiving the second control information. As such, the UE 115-c may communicate with the TRP 505 and the TRP 505 may communicate with the network entity 105-b while operating as an additional TRP.

At 530, the UE 115 c may receive additional control information that may be indicative of an IE that includes an indication to remove the TRP 505 from the configured inter-mobility TRP set. In some examples, the additional control information may be included in RRC signaling or L3 signaling. At 535, the UE 115-c may remove the TRP 505 based on the additional control information received at 530.

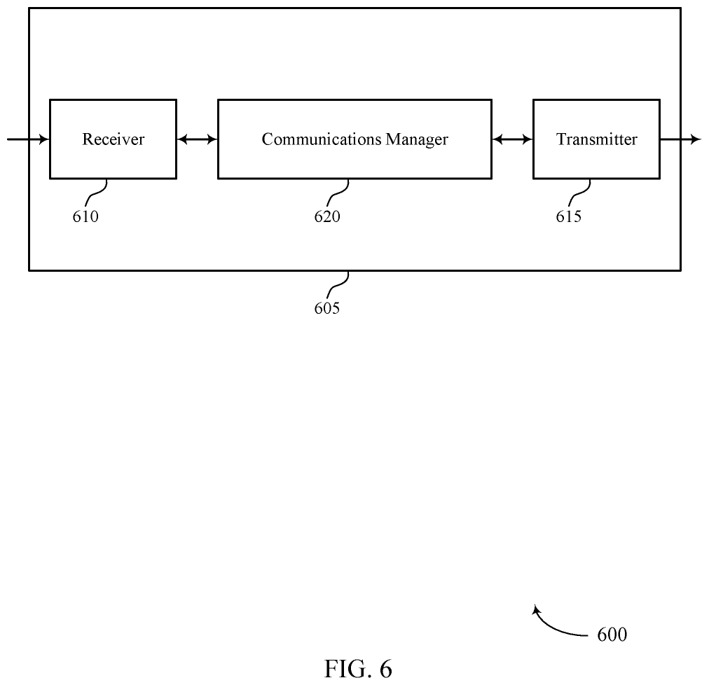

FIG. 6 shows a block diagram 600 of a device 605 that supports configuration of multi-TRPs for inter-cell mobility in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to configuration of multi-TRPs for inter-cell mobility). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuration of multi-TRPs for inter-cell mobility). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of configuration of multi-TRPs for inter-cell mobility as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving first control information indicative of an information element that includes a set of inter-cell mobility parameters for communication between the UE and a set of TRPs. The communications manager 620 may be configured as or otherwise support a means for receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The communications manager 620 may be configured as or otherwise support a means for communicating with a network entity via the TRP in accordance with the change in operating status.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and reduced power consumption. Using other methods, in order to transition an additional TRP to a primary TRP, the UE or the device 605 may undergo a handover procedure which may utilize L3 signaling. Using the method as describe herein, the UE or the device 605 may transition an additional TRP to a primary TRP using L1 or L2 signaling which may be associated with less processing and may be more efficient than L3 signaling.

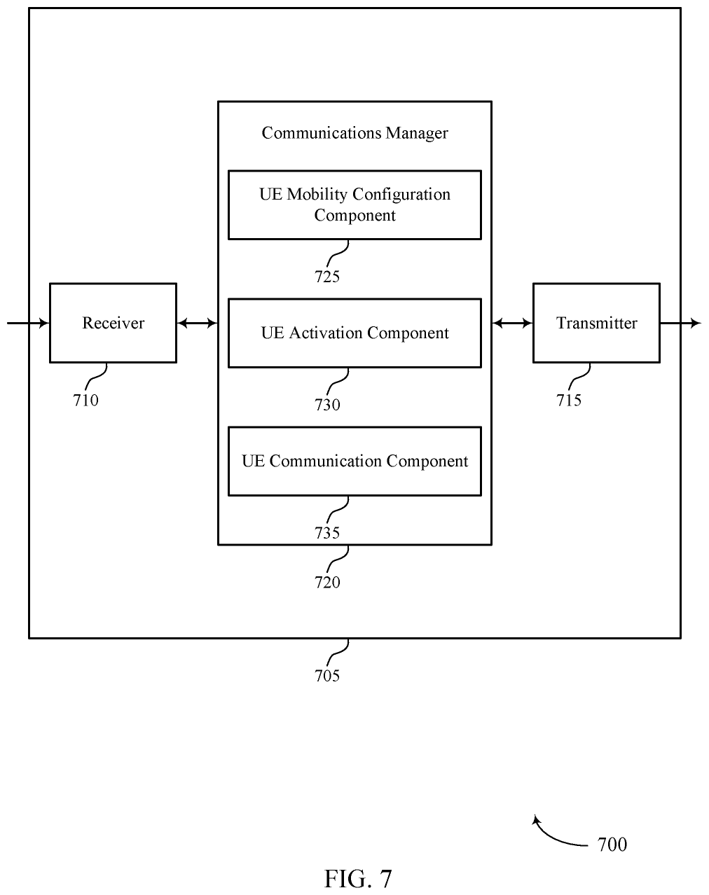

FIG. 7 shows a block diagram 700 of a device 705 that supports configuration of multi-TRPs for inter-cell mobility in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to configuration of multi-TRPs for inter-cell mobility). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configuration of multi-TRPs for inter-cell mobility). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of configuration of multi-TRPs for inter-cell mobility as described herein. For example, the communications manager 720 may include a UE mobility configuration component 725, a UE activation component 730, a UE communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The UE mobility configuration component 725 may be configured as or otherwise support a means for receiving first control information indicative of an information element that includes a set of inter-cell mobility parameters for communication between the UE and a set of TRPs. The UE activation component 730 may be configured as or otherwise support a means for receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The UE communication component 735 may be configured as or otherwise support a means for communicating with a network entity via the TRP in accordance with the change in operating status.

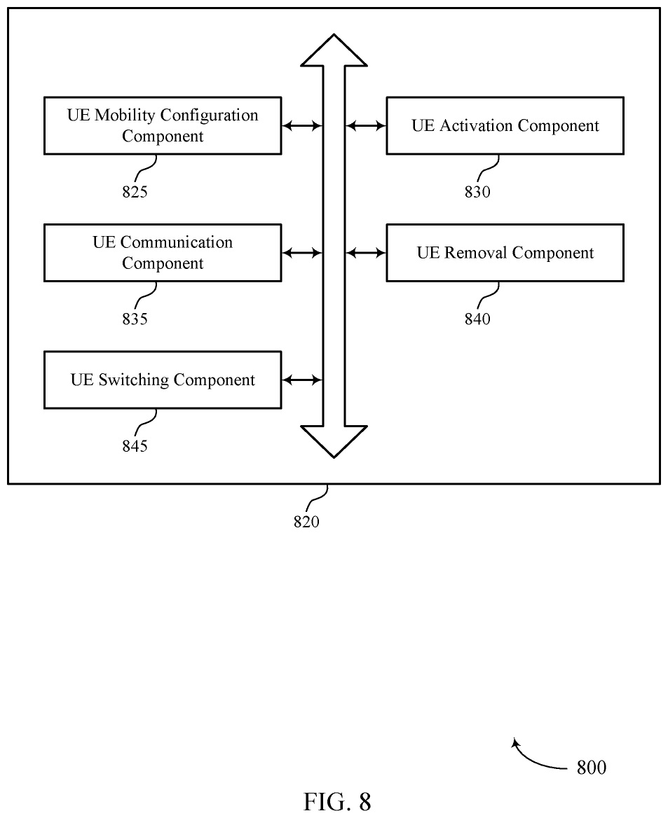

FIG. 8 shows a block diagram 800 of a communications manager 820 that supports configuration of multi-TRPs for inter-cell mobility in accordance with one or more aspects of the present disclosure. The communications manager 820 may be an example of aspects of a communications manager 620, a communications manager 720, or both, as described herein. The communications manager 820, or various components thereof, may be an example of means for performing various aspects of configuration of multi-TRPs for inter-cell mobility as described herein. For example, the communications manager 820 may include a UE mobility configuration component 825, a UE activation component 830, a UE communication component 835, a UE removal component 840, a UE switching component 845, or any combination thereof. Each of these components may communicate, directly or indirectly, with one another (e.g., via one or more buses).

The communications manager 820 may support wireless communication at a UE in accordance with examples as disclosed herein. The UE mobility configuration component 825 may be configured as or otherwise support a means for receiving first control information indicative of an information element that includes a set of inter-cell mobility parameters for communication between the UE and a set of TRPs. The UE activation component 830 may be configured as or otherwise support a means for receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The UE communication component 835 may be configured as or otherwise support a means for communicating with a network entity via the TRP in accordance with the change in operating status.

In some examples, the UE mobility configuration component 825 may be configured as or otherwise support a means for receiving additional control information indicative of the set of TRPs to which the set of inter-cell mobility parameters is applicable.

In some examples, the UE removal component 840 may be configured as or otherwise support a means for receiving additional control information indicative of one or more TRPs of the set of TRPs to which the set of inter-cell mobility parameters is no longer applicable.

In some examples, the additional control information includes a set of bits. In some examples, each bit of the set of bits corresponds to a respective TRP of a set of multiple TRPs included in a serving cell of the network entity. In some examples, a logic value of the each bit of the set of bits is indicative of whether the set of inter-cell mobility parameters is no longer applicable to the respective TRP.

In some examples, the additional control information includes a set of bits. In some examples, each bit of the set of bits corresponds to a respective TRP of the set of TRPs. In some examples, a logic value of the each bit of the set of bits is indicative of whether the set of inter-cell mobility parameters is no longer applicable to the respective TRP.

In some examples, the UE removal component 840 may be configured as or otherwise support a means for removing the one or more TRPs from the set of TRPs based on receiving the additional control information.

In some examples, the UE communication component 835 may be configured as or otherwise support a means for communicating, prior to receiving the second control information, with the network entity via the TRP, where the TRP is operating, prior to receiving the second control information, as the additional TRP.

In some examples, the corresponding inter-cell mobility parameter includes only a first configuration for the TRP to communicate with the network entity while operating as the primary TRP or both the first configuration and a second configuration for the TRP to communicate with the network entity while operating as the primary TRP or as the additional TRP, respectively.

In some examples, the UE switching component 845 may be configured as or otherwise support a means for switching from communicating with the network entity via the TRP while the TRP is operating as the additional TRP to communicating with the network entity via the TRP while the TRP is operating as the primary TRP based on receiving the second control information and applying a first configuration which is for the TRP to communicate with the network entity while operating as the primary TRP.

In some examples, the set of inter-cell mobility parameters includes both the first configuration and a second configuration which is for the TRP to communicate with the network entity while operating as the additional TRP, and the UE switching component 845 may be configured as or otherwise support a means for switching from communicating with the network entity via the TRP while the TRP is operating as the primary TRP to communicating with the network entity via the TRP while the TRP is operating as the additional TRP based on applying the second configuration.

In some examples, the UE communication component 835 may be configured as or otherwise support a means for communicating, prior to receiving the second control information, with the network entity via the TRP, where the TRP is operating, prior to receiving the second control information, as the primary TRP.

In some examples, the corresponding inter-cell mobility parameter includes only a second configuration for the TRP to communicate with the network entity while operating as the additional TRP or both the second configuration and a first configuration for the TRP to communicate with the network entity while operating as the additional TRP or as the primary TRP, respectively.

In some examples, the UE switching component 845 may be configured as or otherwise support a means for switching from communicating with the network entity via the TRP while the TRP is operating as the primary TRP to communicating with the network entity via the TRP while the TRP is operating as the additional TRP based on receiving the second control information and applying a second configuration which is for the TRP to communicate with the network entity while operating as the additional TRP.

In some examples, the set of inter-cell mobility parameters includes both the second configuration and a first configuration which is for the TRP to communicate with the network entity while operating as the primary TRP, and the UE switching component 845 may be configured as or otherwise support a means for switching from communicating with the network entity via the TRP while the TRP is operating as the additional TRP to communicating with the network entity via the TRP while the TRP is operating as the primary TRP based on applying the first configuration.

In some examples, to support receiving the first control information, the UE mobility configuration component 825 may be configured as or otherwise support a means for receiving RRC signaling that includes the first control information.

In some examples, to support receiving the second control information, the UE activation component 830 may be configured as or otherwise support a means for receiving L1 signaling or L2 signaling that includes the second control information.

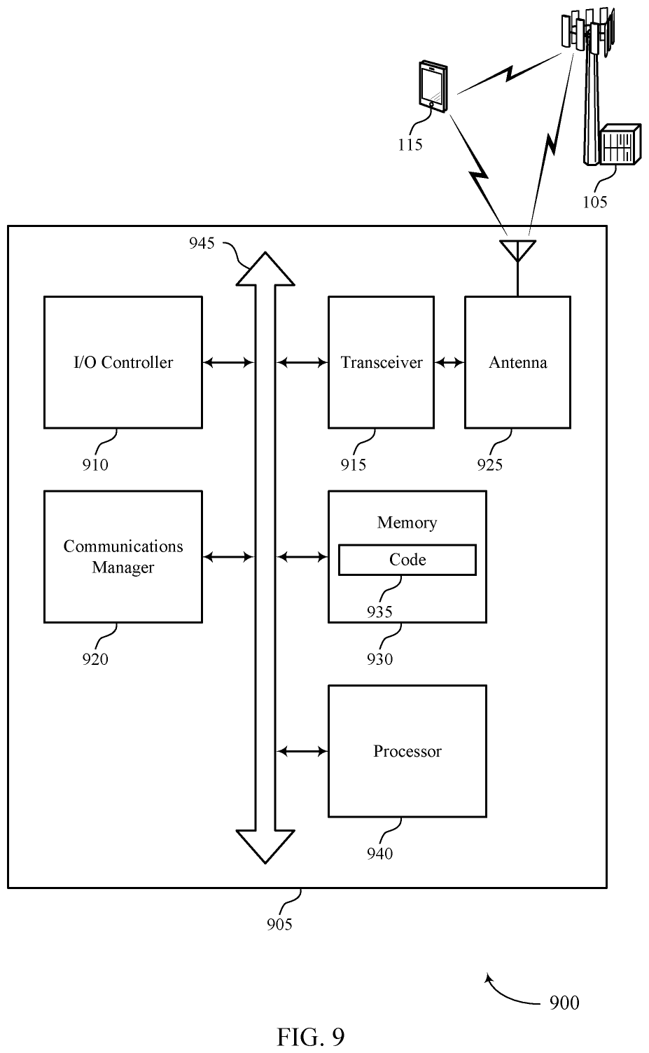

FIG. 9 shows a diagram of a system 900 including a device 905 that supports configuration of multi-TRPs for inter-cell mobility in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting configuration of multi-TRPs for inter-cell mobility). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving first control information indicative of an information element that includes a set of inter-cell mobility parameters for communication between the UE and a set of TRPs. The communications manager 920 may be configured as or otherwise support a means for receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The communications manager 920 may be configured as or otherwise support a means for communicating with a network entity via the TRP in accordance with the change in operating status.

By including or configuring the communications manager 920 in accordance with examples as described herein, the device 905 may support techniques reduced latency, improved user experience related to reduced processing, and reduced power consumption.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of configuration of multi-TRPs for inter-cell mobility as described herein, or the processor 940 and the memory 930 may be otherwise configured to perform or support such operations.

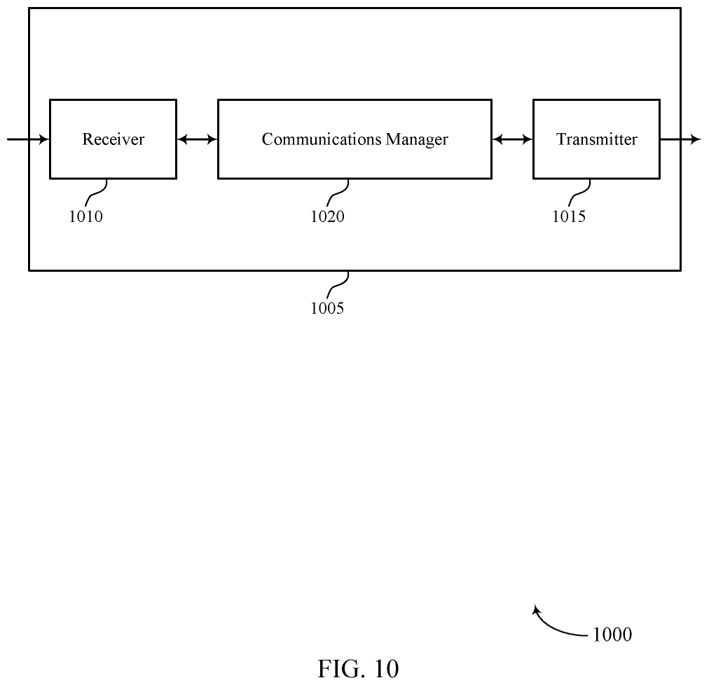

FIG. 10 shows a block diagram 1000 of a device 1005 that supports configuration of multi-TRPs for inter-cell mobility in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of configuration of multi-TRPs for inter-cell mobility as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting first control information indicative of an information element that includes a set of inter-cell mobility parameters for communication between a UE and a set of TRPs. The communications manager 1020 may be configured as or otherwise support a means for transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The communications manager 1020 may be configured as or otherwise support a means for communicating with the UE via the TRP in accordance with the change in operating status.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing and reduced power consumption.

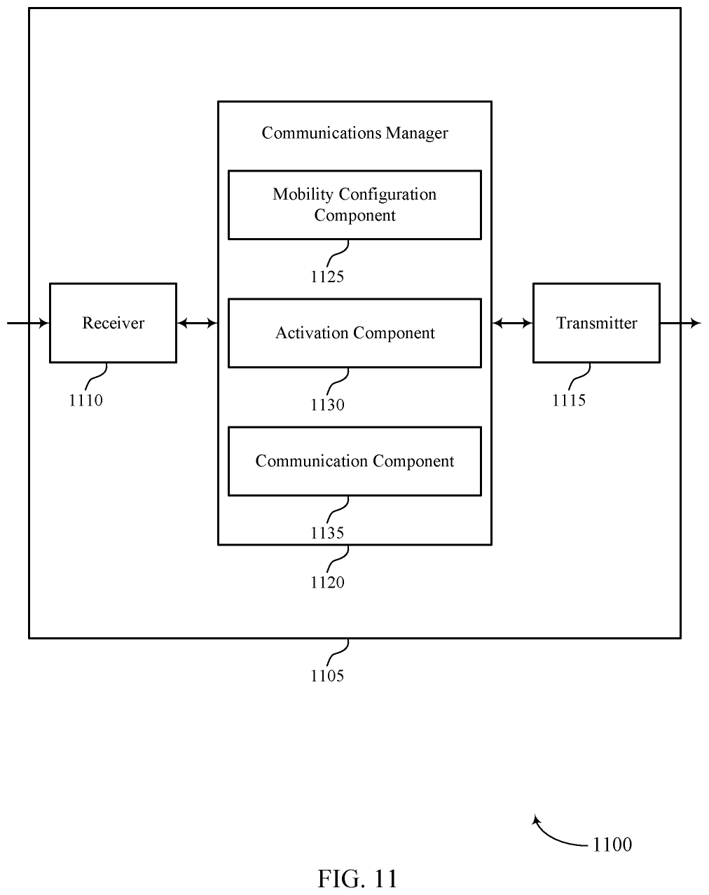

FIG. 11 shows a block diagram 1100 of a device 1105 that supports configuration of multi-TRPs for inter-cell mobility in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of configuration of multi-TRPs for inter-cell mobility as described herein. For example, the communications manager 1120 may include a mobility configuration component 1125, an activation component 1130, a communication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The mobility configuration component 1125 may be configured as or otherwise support a means for transmitting first control information indicative of an information element that includes a set of inter-cell mobility parameters for communication between a UE and a set of TRPs. The activation component 1130 may be configured as or otherwise support a means for transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The communication component 1135 may be configured as or otherwise support a means for communicating with the UE via the TRP in accordance with the change in operating status.

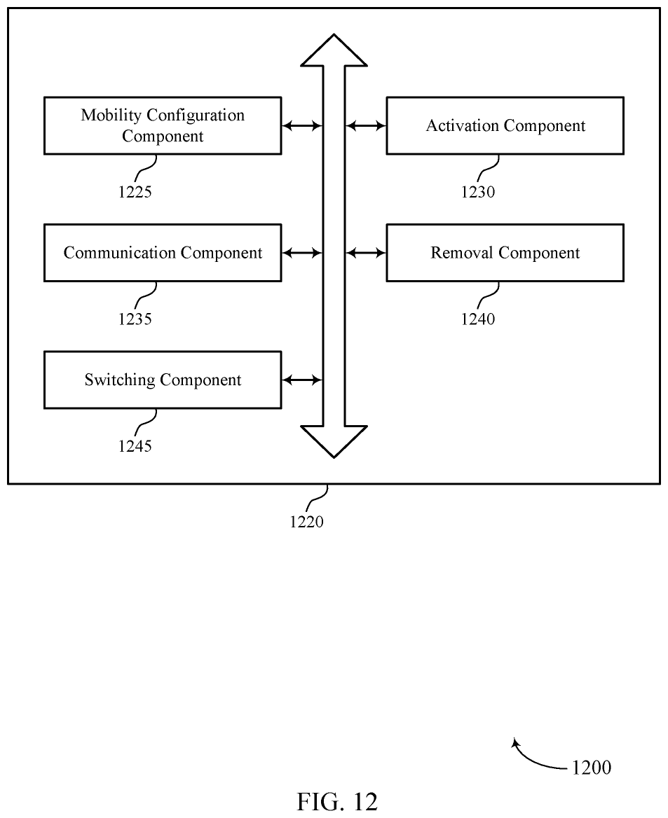

FIG. 12 shows a block diagram 1200 of a communications manager 1220 that supports configuration of multi-TRPs for inter-cell mobility in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of configuration of multi-TRPs for inter-cell mobility as described herein. For example, the communications manager 1220 may include a mobility configuration component 1225, an activation component 1230, a communication component 1235, a removal component 1240, a switching component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The mobility configuration component 1225 may be configured as or otherwise support a means for transmitting first control information indicative of an information element that includes a set of inter-cell mobility parameters for communication between a UE and a set of TRPs. The activation component 1230 may be configured as or otherwise support a means for transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The communication component 1235 may be configured as or otherwise support a means for communicating with the UE via the TRP in accordance with the change in operating status.

In some examples, the mobility configuration component 1225 may be configured as or otherwise support a means for transmitting additional control information indicative of the set of TRPs to which the set of inter-cell mobility parameters is applicable.

In some examples, the removal component 1240 may be configured as or otherwise support a means for transmitting additional control information indicative of one or more TRPs of the set of TRPs to which the set of inter-cell mobility parameters is no longer applicable.

In some examples, the additional control information includes a set of bits. In some examples, each bit of the set of bits corresponds to a respective TRP of a set of multiple TRPs included in a serving cell of the network entity. In some examples, a logic value of the each bit of the set of bits is indicative of whether the set of inter-cell mobility parameters is no longer applicable to the respective TRP.

In some examples, the additional control information includes a set of bits. In some examples, each bit of the set of bits corresponds to a respective TRP of the set of TRPs. In some examples, a logic value of the each bit of the set of bits is indicative of whether the set of inter-cell mobility parameters is no longer applicable to the respective TRP.

In some examples, the communication component 1235 may be configured as or otherwise support a means for communicating, prior to transmitting the second control information, with the UE via the TRP, where the TRP is operating, prior to transmitting the second control information, as the additional TRP.

In some examples, the corresponding inter-cell mobility parameter includes only a first configuration for the TRP to communicate with the UE while operating as the primary TRP or both the first configuration and a second configuration for the TRP to communicate with the UE while operating as the primary TRP or as the additional TRP, respectively.

In some examples, the switching component 1245 may be configured as or otherwise support a means for switching from communicating with the UE via the TRP while the TRP is operating as the additional TRP to communicating with UE via the TRP while the TRP is operating as the primary TRP based on transmitting the second control information and applying a first configuration which is for the TRP to communicate with the UE while operating as the primary TRP.

In some examples, the set of inter-cell mobility parameters includes both the first configuration and a second configuration which is for the TRP to communicate with the UE while operating as the additional TRP, and the switching component 1245 may be configured as or otherwise support a means for switching from communicating with the UE via the TRP while the TRP is operating as the primary TRP to communicating with the UE via the TRP while the TRP is operating as the additional TRP based on applying the second configuration.

In some examples, the communication component 1235 may be configured as or otherwise support a means for communicating, prior to transmitting the second control information, with the UE via the TRP, where the TRP is operating, prior to transmitting the second control information, as the primary TRP.

In some examples, the corresponding inter-cell mobility parameter includes only a second configuration for the TRP to communicate with the UE while operating as the additional TRP or both the second configuration and a first configuration for the TRP to communicate with the UE while operating as the additional TRP or as the primary TRP, respectively.

In some examples, the switching component 1245 may be configured as or otherwise support a means for switching from communicating with the UE via the TRP while the TRP is operating as the primary TRP to communicating with the UE via the TRP while the TRP is operating as the additional TRP based on transmitting the second control information and applying a second configuration which is for the TRP to communicate with the UE while operating as the additional TRP.

In some examples, the set of inter-cell mobility parameters includes both the second configuration and a first configuration which is for the TRP to communicate with the UE while operating as the primary TRP, and the switching component 1245 may be configured as or otherwise support a means for switching from communicating with the UE via the TRP while the TRP is operating as the additional TRP to communicating with the UE via the TRP while the TRP is operating as the primary TRP based on applying the first configuration.

In some examples, to support transmitting the first control information, the mobility configuration component 1225 may be configured as or otherwise support a means for transmitting RRC signaling that includes the first control information.

In some examples, to support transmitting the second control information, the activation component 1230 may be configured as or otherwise support a means for transmitting L1 signaling or L2 signaling that includes the second control information.

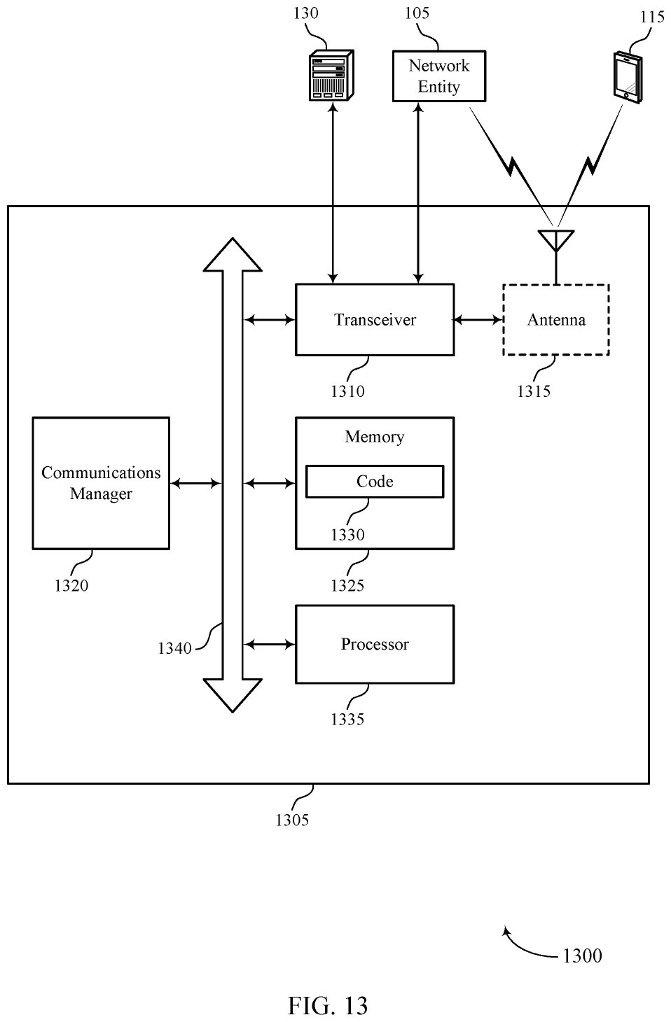

FIG. 13 shows a diagram of a system 1300 including a device 1305 that supports configuration of multi-TRPs for inter-cell mobility in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting configuration of multi-TRPs for inter-cell mobility). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting first control information indicative of an information element that includes a set of inter-cell mobility parameters for communication between a UE and a set of TRPs. The communications manager 1320 may be configured as or otherwise support a means for transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The communications manager 1320 may be configured as or otherwise support a means for communicating with the UE via the TRP in accordance with the change in operating status.

By including or configuring the communications manager 1320 in accordance with examples as described herein, the device 1305 may support techniques for reduced latency, improved user experience related to reduced processing, and reduced power consumption.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of configuration of multi-TRPs for inter-cell mobility as described herein, or the processor 1335 and the memory 1325 may be otherwise configured to perform or support such operations.

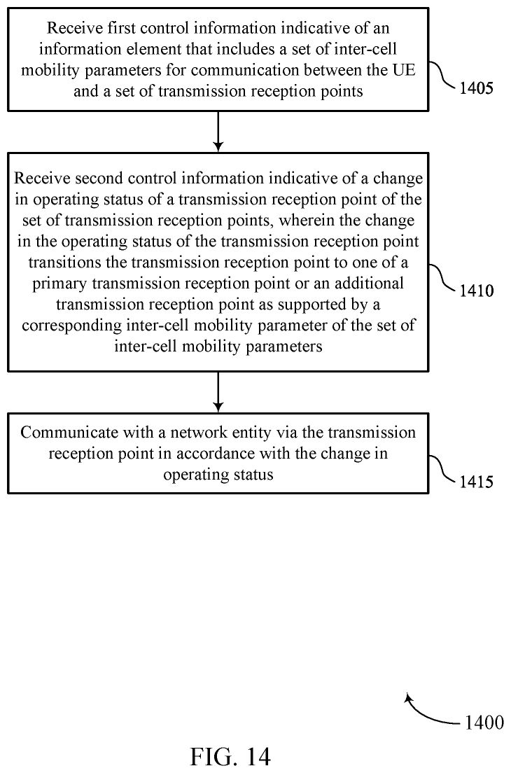

FIG. 14 shows a flowchart illustrating a method 1400 that supports configuration of multi-TRPs for inter-cell mobility in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control information indicative of an information element that includes a set of inter-cell mobility parameters for communication between the UE and a set of TRPs. The operations of 1405 may be performed in accordance with examples as disclosed herein. In some examples, aspects of the operations of 1405 may be performed by a UE mobility configuration component 825 as described with reference to FIG. 8.

At 1410, the method may include receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The operations of 1410 may be performed in accordance with examples as disclosed herein. In some examples, aspects of the operations of 1410 may be performed by a UE activation component 830 as described with reference to FIG. 8.

At 1415, the method may include communicating with a network entity via the TRP in accordance with the change in operating status. The operations of 1415 may be performed in accordance with examples as disclosed herein. In some examples, aspects of the operations of 1415 may be performed by a UE communication component 835 as described with reference to FIG. 8.

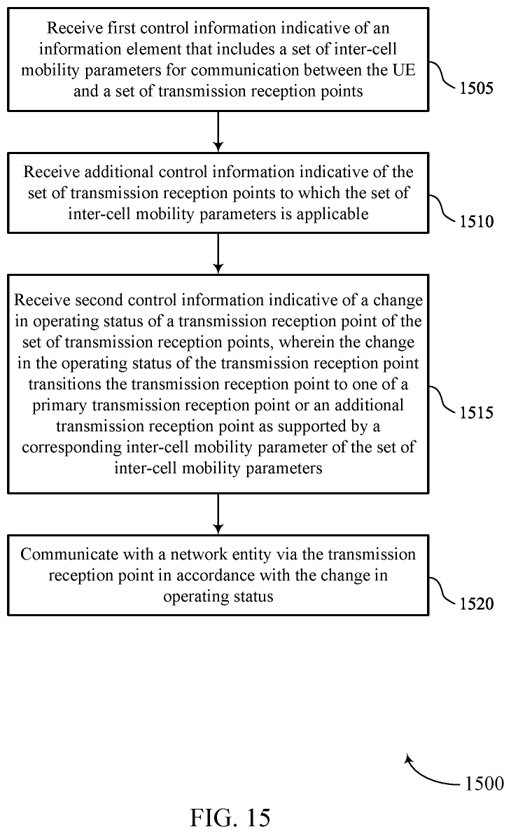

FIG. 15 shows a flowchart illustrating a method 1500 that supports configuration of multi-TRPs for inter-cell mobility in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first control information indicative of an information element that includes a set of inter-cell mobility parameters for communication between the UE and a set of TRPs. The operations of 1505 may be performed in accordance with examples as disclosed herein. In some examples, aspects of the operations of 1505 may be performed by a UE mobility configuration component 825 as described with reference to FIG. 8.

At 1510, the method may include receiving additional control information indicative of the set of TRPs to which the set of inter-cell mobility parameters is applicable. The operations of 1510 may be performed in accordance with examples as disclosed herein. In some examples, aspects of the operations of 1510 may be performed by a UE mobility configuration component 825 as described with reference to FIG. 8.

At 1515, the method may include receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The operations of 1515 may be performed in accordance with examples as disclosed herein. In some examples, aspects of the operations of 1515 may be performed by a UE activation component 830 as described with reference to FIG. 8.

At 1520, the method may include communicating with a network entity via the TRP in accordance with the change in operating status. The operations of 1520 may be performed in accordance with examples as disclosed herein. In some examples, aspects of the operations of 1520 may be performed by a UE communication component 835 as described with reference to FIG. 8.

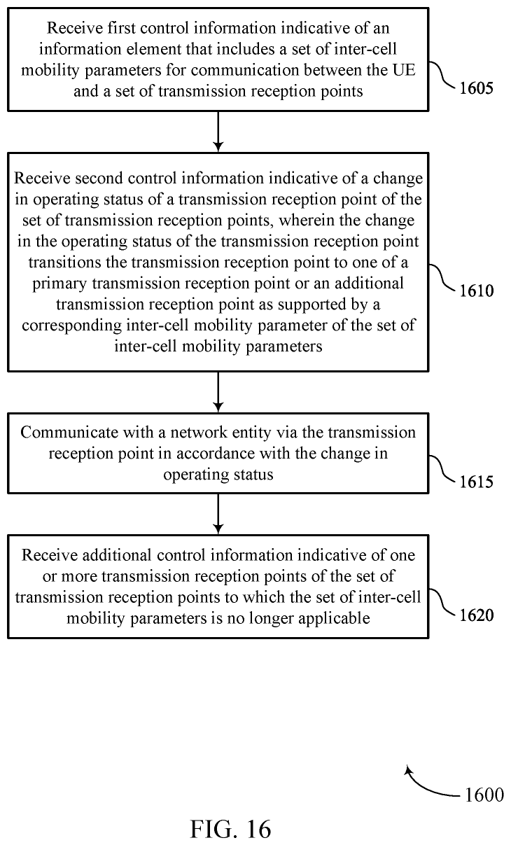

FIG. 16 shows a flowchart illustrating a method 1600 that supports configuration of multi-TRPs for inter-cell mobility in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving first control information indicative of an information element that includes a set of inter-cell mobility parameters for communication between the UE and a set of TRPs. The operations of 1605 may be performed in accordance with examples as disclosed herein. In some examples, aspects of the operations of 1605 may be performed by a UE mobility configuration component 825 as described with reference to FIG. 8.

At 1610, the method may include receiving second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The operations of 1610 may be performed in accordance with examples as disclosed herein. In some examples, aspects of the operations of 1610 may be performed by a UE activation component 830 as described with reference to FIG. 8.

At 1615, the method may include communicating with a network entity via the TRP in accordance with the change in operating status. The operations of 1615 may be performed in accordance with examples as disclosed herein. In some examples, aspects of the operations of 1615 may be performed by a UE communication component 835 as described with reference to FIG. 8.

At 1620, the method may include receiving additional control information indicative of one or more TRPs of the set of TRPs to which the set of inter-cell mobility parameters is no longer applicable. The operations of 1620 may be performed in accordance with examples as disclosed herein. In some examples, aspects of the operations of 1620 may be performed by a UE removal component 840 as described with reference to FIG. 8.

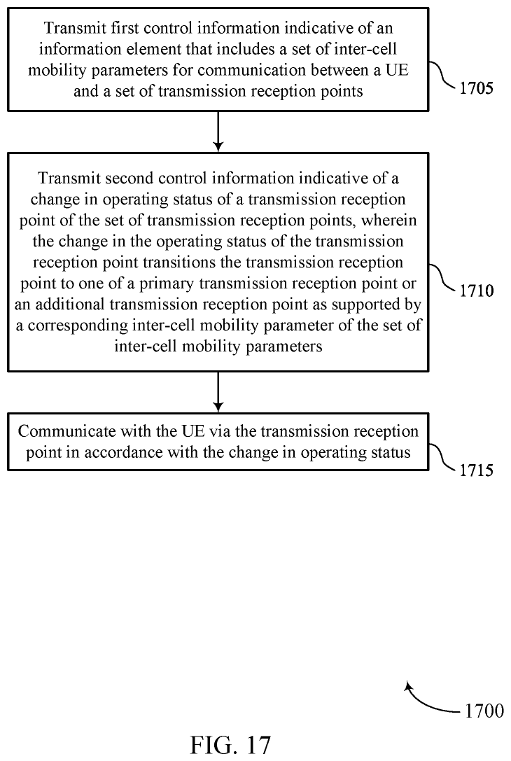

FIG. 17 shows a flowchart illustrating a method 1700 that supports configuration of multi-TRPs for inter-cell mobility in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first control information indicative of an information element that includes a set of inter-cell mobility parameters for communication between a UE and a set of TRPs. The operations of 1705 may be performed in accordance with examples as disclosed herein. In some examples, aspects of the operations of 1705 may be performed by a mobility configuration component 1225 as described with reference to FIG. 12.

At 1710, the method may include transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The operations of 1710 may be performed in accordance with examples as disclosed herein. In some examples, aspects of the operations of 1710 may be performed by an activation component 1230 as described with reference to FIG. 12.

At 1715, the method may include communicating with the UE via the TRP in accordance with the change in operating status. The operations of 1715 may be performed in accordance with examples as disclosed herein. In some examples, aspects of the operations of 1715 may be performed by a communication component 1235 as described with reference to FIG. 12.

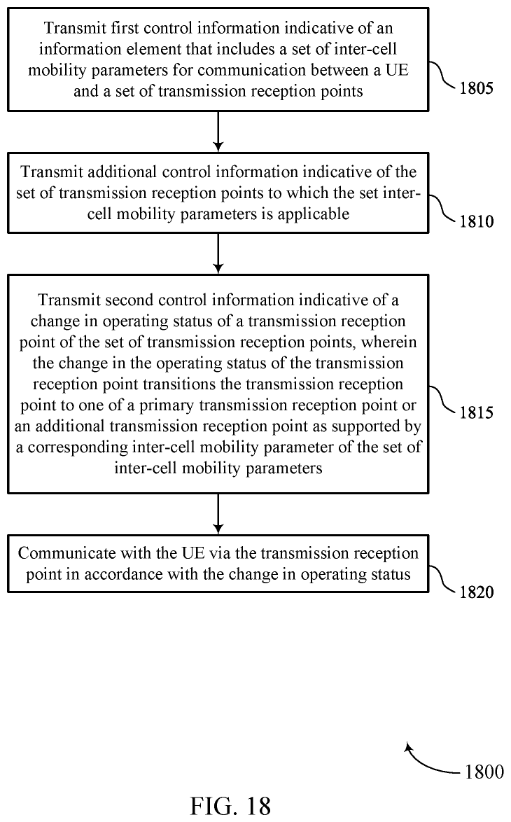

FIG. 18 shows a flowchart illustrating a method 1800 that supports configuration of multi-TRPs for inter-cell mobility in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting first control information indicative of an information element that includes a set of inter-cell mobility parameters for communication between a UE and a set of TRPs. The operations of 1805 may be performed in accordance with examples as disclosed herein. In some examples, aspects of the operations of 1805 may be performed by a mobility configuration component 1225 as described with reference to FIG. 12.

At 1810, the method may include transmitting additional control information indicative of the set of TRPs to which the set of inter-cell mobility parameters is applicable. The operations of 1810 may be performed in accordance with examples as disclosed herein. In some examples, aspects of the operations of 1810 may be performed by a mobility configuration component 1225 as described with reference to FIG. 12.

At 1815, the method may include transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The operations of 1815 may be performed in accordance with examples as disclosed herein. In some examples, aspects of the operations of 1815 may be performed by an activation component 1230 as described with reference to FIG. 12.

At 1820, the method may include communicating with the UE via the TRP in accordance with the change in operating status. The operations of 1820 may be performed in accordance with examples as disclosed herein. In some examples, aspects of the operations of 1820 may be performed by a communication component 1235 as described with reference to FIG. 12.

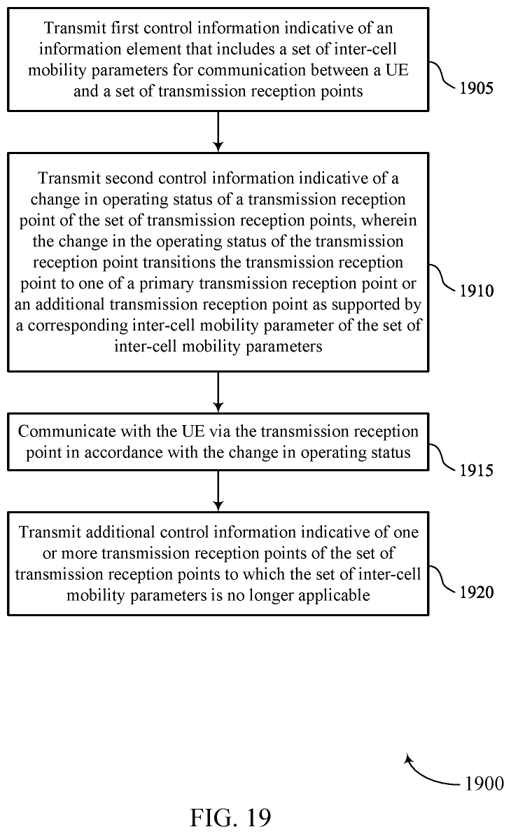

FIG. 19 shows a flowchart illustrating a method 1900 that supports configuration of multi-TRPs for inter-cell mobility in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting first control information indicative of an information element that includes a set of inter-cell mobility parameters for communication between a UE and a set of TRPs. The operations of 1905 may be performed in accordance with examples as disclosed herein. In some examples, aspects of the operations of 1905 may be performed by a mobility configuration component 1225 as described with reference to FIG. 12.

At 1910, the method may include transmitting second control information indicative of a change in operating status of a TRP of the set of TRPs, where the change in the operating status of the TRP transitions the TRP to one of a primary TRP or an additional TRP as supported by a corresponding inter-cell mobility parameter of the set of inter-cell mobility parameters. The operations of 1910 may be performed in accordance with examples as disclosed herein. In some examples, aspects of the operations of 1910 may be performed by an activation component 1230 as described with reference to FIG. 12.

At 1915, the method may include communicating with the UE via the TRP in accordance with the change in operating status. The operations of 1915 may be performed in accordance with examples as disclosed herein. In some examples, aspects of the operations of 1915 may be performed by a communication component 1235 as described with reference to FIG. 12.

At 1920, the method may include transmitting additional control information indicative of one or more TRPs of the set of TRPs to which the set of inter-cell mobility parameters is no longer applicable. The operations of 1920 may be performed in accordance with examples as disclosed herein. In some examples, aspects of the operations of 1920 may be performed by a removal component 1240 as described with reference to FIG. 12.

The following provides an overview of aspects of the present disclosure:
Aspect 1: A method for wireless communication at a UE, comprising: receiving first control information indicative of an IE that includes a set of inter-cell mobility parameters for communication between the UE and a set of TRPs; receiving second control information indicative of a change in operating status of a TRP of the set of TRPs, wherein the change in the operating status of the TRP transitions the TRP to one of a primary TRP or an additional TRP as supported by a corresponding inter-cell mobility parameter of the set of inter-cell mobility parameters; and communicating with a network entity via the TRP in accordance with the change in operating status.
Aspect 2: The method of aspect 1, further comprising: receiving additional control information indicative of the set of TRPs to which the set of inter-cell mobility parameters is applicable.
Aspect 3: The method of any of aspects 1 through 2, further comprising: receiving additional control information indicative of one or more TRPs of the set of TRPs to which the set of inter-cell mobility parameters is no longer applicable.
Aspect 4: The method of aspect 3, wherein the additional control information comprises a set of bits, each bit of the set of bits corresponds to a respective TRP of a plurality of TRPs included in a serving cell of the network entity, and a logic value of the each bit of the set of bits is indicative of whether the set of inter-cell mobility parameters is no longer applicable to the respective TRP.
Aspect 5: The method of aspect 3, wherein the additional control information comprises a set of bits, each bit of the set of bits corresponds to a respective TRP of the set of TRPs, and a logic value of the each bit of the set of bits is indicative of whether the set of inter-cell mobility parameters is no longer applicable to the respective TRP.
Aspect 6: The method of any of aspects 3 through 5, further comprising: removing the one or more TRPs from the set of TRPs based at least in part on receiving the additional control information.
Aspect 7: The method of any of aspects 1 through 6, further comprising: communicating, prior to receiving the second control information, with the network entity via the TRP, wherein the TRP is operating, prior to receiving the second control information, as the additional TRP.
Aspect 8: The method of aspect 7, wherein the corresponding inter-cell mobility parameter comprises only a first configuration for the TRP to communicate with the network entity while operating as the primary TRP or both the first configuration and a second configuration for the TRP to communicate with the network entity while operating as the primary TRP or as the additional TRP, respectively.
Aspect 9: The method of any of aspects 7 through 8, further comprising: switching from communicating with the network entity via the TRP while the TRP is operating as the additional TRP to communicating with the network entity via the TRP while the TRP is operating as the primary TRP based at least in part on receiving the second control information and applying a first configuration which is for the TRP to communicate with the network entity while operating as the primary TRP.
Aspect 10: The method of aspect 9, wherein the set of inter-cell mobility parameters comprises both the first configuration and a second configuration which is for the TRP to communicate with the network entity while operating as the additional TRP, the method further comprising: switching from communicating with the network entity via the TRP while the TRP is operating as the primary TRP to communicating with the network entity via the TRP while the TRP is operating as the additional TRP based at least in part on applying the second configuration.
Aspect 11: The method of any of aspects 1 through 10, further comprising: communicating, prior to receiving the second control information, with the network entity via the TRP, wherein the TRP is operating, prior to receiving the second control information, as the primary TRP.
Aspect 12: The method of aspect 11, wherein the corresponding inter-cell mobility parameter comprises only a second configuration for the TRP to communicate with the network entity while operating as the additional TRP or both the second configuration and a first configuration for the TRP to communicate with the network entity while operating as the additional TRP or as the primary TRP, respectively.
Aspect 13: The method of any of aspects 11 through 12, further comprising: switching from communicating with the network entity via the TRP while the TRP is operating as the primary TRP to communicating with the network entity via the TRP while the TRP is operating as the additional TRP based at least in part on receiving the second control information and applying a second configuration which is for the TRP to communicate with the network entity while operating as the additional TRP.
Aspect 14: The method of aspect 13, wherein the set of inter-cell mobility parameters comprises both the second configuration and a first configuration which is for the TRP to communicate with the network entity while operating as the primary TRP, the method further comprising: switching from communicating with the network entity via the TRP while the TRP is operating as the additional TRP to communicating with the network entity via the TRP while the TRP is operating as the primary TRP based at least in part on applying the first configuration.
Aspect 15: The method of any of aspects 1 through 14, wherein receiving the first control information comprises: receiving RRC signaling that comprises the first control information.
Aspect 16: The method of any of aspects 1 through 15, wherein receiving the second control information comprises: receiving L1 signaling or L2 signaling that comprises the second control information.
Aspect 17: A method for wireless communication at a network entity, comprising: transmitting first control information indicative of an IE that includes a set of inter-cell mobility parameters for communication between a UE and a set of TRPs; transmitting second control information indicative of a change in operating status of a TRP of the set of TRPs, wherein the change in the operating status of the TRP transitions the TRP to one of a primary TRP or an additional TRP as supported by a corresponding inter-cell mobility parameter of the set of inter-cell mobility parameters; and communicating with the UE via the TRP in accordance with the change in operating status.
Aspect 18: The method of aspect 17, further comprising: transmitting additional control information indicative of the set of TRPs to which the set inter-cell mobility parameters is applicable.
Aspect 19: The method of any of aspects 17 through 18, further comprising: transmitting additional control information indicative of one or more TRPs of the set of TRPs to which the set of inter-cell mobility parameters is no longer applicable.
Aspect 20: The method of aspect 19, wherein the additional control information comprises a set of bits, each bit of the set of bits corresponds to a respective TRP of a plurality of TRPs included in a serving cell of the network entity, and a logic value of the each bit of the set of bits is indicative of whether the set of inter-cell mobility parameters is no longer applicable to the respective TRP.
Aspect 21: The method of aspect 19, wherein the additional control information comprises a set of bits, each bit of the set of bits corresponds to a respective TRP of the set of TRPs, and a logic value of the each bit of the set of bits is indicative of whether the set of inter-cell mobility parameters is no longer applicable to the respective TRP.
Aspect 22: The method of any of aspects 17 through 21, further comprising: communicating, prior to transmitting the second control information, with the UE via the TRP, wherein the TRP is operating, prior to transmitting the second control information, as the additional TRP.
Aspect 23: The method of aspect 22, wherein the corresponding inter-cell mobility parameter comprises only a first configuration for the TRP to communicate with the UE while operating as the primary TRP or both the first configuration and a second configuration for the TRP to communicate with the UE while operating as the primary TRP or as the additional TRP, respectively.
Aspect 24: The method of any of aspects 22 through 23, further comprising: switching from communicating with the UE via the TRP while the TRP is operating as the additional TRP to communicating with UE via the TRP while the TRP is operating as the primary TRP based at least in part on transmitting the second control information and applying a first configuration which is for the TRP to communicate with the UE while operating as the primary TRP.
Aspect 25: The method of aspect 24, wherein the set of inter-cell mobility parameters comprises both the first configuration and a second configuration which is for the TRP to communicate with the UE while operating as the additional TRP, the method further comprising: switching from communicating with the UE via the TRP while the TRP is operating as the primary TRP to communicating with the UE via the TRP while the TRP is operating as the additional TRP based at least in part on applying the second configuration.
Aspect 26: The method of any of aspects 17 through 25, further comprising: communicating, prior to transmitting the second control information, with the UE via the TRP, wherein the TRP is operating, prior to transmitting the second control information, as the primary TRP.
Aspect 27: The method of aspect 26, wherein the corresponding inter-cell mobility parameter comprises only a second configuration for the TRP to communicate with the UE while operating as the additional TRP or both the second configuration and a first configuration for the TRP to communicate with the UE while operating as the additional TRP or as the primary TRP, respectively.
Aspect 28: The method of any of aspects 26 through 27, further comprising: switching from communicating with the UE via the TRP while the TRP is operating as the primary TRP to communicating with the UE via the TRP while the TRP is operating as the additional TRP based at least in part on transmitting the second control information and applying a second configuration which is for the TRP to communicate with the UE while operating as the additional TRP.
Aspect 29: The method of aspect 28, wherein the set of inter-cell mobility parameters comprises both the second configuration and a first configuration which is for the TRP to communicate with the UE while operating as the primary TRP, the method further comprising: switching from communicating with the UE via the TRP while the TRP is operating as the additional TRP to communicating with the UE via the TRP while the TRP is operating as the primary TRP based at least in part on applying the first configuration.
Aspect 30: The method of any of aspects 17 through 29, wherein transmitting the first control information comprises: transmitting RRC signaling that comprises the first control information.
Aspect 31: The method of any of aspects 17 through 30, wherein transmitting the second control information comprises: transmitting L1 signaling or L2 signaling that comprises the second control information.
Aspect 32: An apparatus for wireless communication at a UE, comprising a processor; memory coupled with the processor; and instructions stored in the memory and executable by the processor to cause the apparatus to perform a method of any of aspects 1 through 16.
Aspect 33: An apparatus for wireless communication at a UE, comprising at least one means for performing a method of any of aspects 1 through 16.
Aspect 34: A non-transitory computer-readable medium storing code for wireless communication at a UE, the code comprising instructions executable by a processor to perform a method of any of aspects 1 through 16.
Aspect 35: An apparatus for wireless communication at a network entity, comprising a processor; memory coupled with the processor; and instructions stored in the memory and executable by the processor to cause the apparatus to perform a method of any of aspects 17 through 31.
Aspect 36: An apparatus for wireless communication at a network entity, comprising at least one means for performing a method of any of aspects 17 through 31.
Aspect 37: A non-transitory computer-readable medium storing code for wireless communication at a network entity, the code comprising instructions executable by a processor to perform a method of any of aspects 17 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
receive first control information indicative of an information element that includes a set of inter-cell mobility parameters for communication between a user equipment (UE) and a set of transmission reception points;
receive second control information indicative of a change in operating status of a transmission reception point of the set of transmission reception points, wherein the change in the operating status of the transmission reception point transitions the transmission reception point to one of a primary transmission reception point or an additional transmission reception point as supported by a corresponding inter-cell mobility parameter of the set of inter-cell mobility parameters; and
communicate with a network entity via the transmission reception point in accordance with the change in operating status.

2. The apparatus of claim 1, wherein the instructions are further executable by the processor to cause the apparatus to:
receive additional control information indicative of the set of transmission reception points to which the set of inter-cell mobility parameters is applicable.

3. The apparatus of claim 1, wherein the instructions are further executable by the processor to cause the apparatus to:
receive additional control information indicative of one or more transmission reception points of the set of transmission reception points to which the set of inter-cell mobility parameters is no longer applicable.

4. The apparatus of claim 3, wherein:
the additional control information comprises a set of bits, each bit of the set of bits corresponds to a respective transmission reception point of a plurality of transmission reception points included in a serving cell of the network entity; and
a logic value of the each bit of the set of bits is indicative of whether the set of inter-cell mobility parameters is no longer applicable to the respective transmission reception point.

5. The apparatus of claim 3, wherein:
the additional control information comprises a set of bits, each bit of the set of bits corresponds to a respective transmission reception point of the set of transmission reception points; and
a logic value of the each bit of the set of bits is indicative of whether the set of inter-cell mobility parameters is no longer applicable to the respective transmission reception point.

6. The apparatus of claim 3, wherein the instructions are further executable by the processor to cause the apparatus to:
remove the one or more transmission reception points from the set of transmission reception points based at least in part on receiving the additional control information.

7. The apparatus of claim 1, wherein the instructions are further executable by the processor to cause the apparatus to:
communicate, prior to receiving the second control information, with the network entity via the transmission reception point, wherein the transmission reception point is operating, prior to receiving the second control information, as the additional transmission reception point.

8. The apparatus of claim 7, wherein the corresponding inter-cell mobility parameter comprises only a first configuration for the transmission reception point to communicate with the network entity while operating as the primary transmission reception point or both the first configuration and a second configuration for the transmission reception point to communicate with the network entity while operating as the primary transmission reception point or as the additional transmission reception point, respectively.

9. The apparatus of claim 7, wherein the instructions are further executable by the processor to cause the apparatus to:
switch from communicating with the network entity via the transmission reception point while the transmission reception point is operating as the additional transmission reception point to communicating with the network entity via the transmission reception point while the transmission reception point is operating as the primary transmission reception point based at least in part on receiving the second control information and applying a first configuration which is for the transmission reception point to communicate with the network entity while operating as the primary transmission reception point.

10. The apparatus of claim 9, wherein the set of inter-cell mobility parameters comprises both the first configuration and a second configuration which is for the transmission reception point to communicate with the network entity while operating as the additional transmission reception point, and the instructions are further executable by the processor to cause the apparatus to:
switch from communicating with the network entity via the transmission reception point while the transmission reception point is operating as the primary transmission reception point to communicating with the network entity via the transmission reception point while the transmission reception point is operating as the additional transmission reception point based at least in part on applying the second configuration.

11. The apparatus of claim 1, wherein the instructions are further executable by the processor to cause the apparatus to:
communicate, prior to receiving the second control information, with the network entity via the transmission reception point, wherein the transmission reception point is operating, prior to receiving the second control information, as the primary transmission reception point.

12. The apparatus of claim 11, wherein the corresponding inter-cell mobility parameter comprises only a second configuration for the transmission reception point to communicate with the network entity while operating as the additional transmission reception point or both the second configuration and a first configuration for the transmission reception point to communicate with the network entity while operating as the additional transmission reception point or as the primary transmission reception point, respectively.

13. The apparatus of claim 11, wherein the instructions are further executable by the processor to cause the apparatus to:
switch from communicating with the network entity via the transmission reception point while the transmission reception point is operating as the primary transmission reception point to communicating with the network entity via the transmission reception point while the transmission reception point is operating as the additional transmission reception point based at least in part on receiving the second control information and applying a second configuration which is for the transmission reception point to communicate with the network entity while operating as the additional transmission reception point.

14. The apparatus of claim 13, wherein the set of inter-cell mobility parameters comprises both the second configuration and a first configuration which is for the transmission reception point to communicate with the network entity while operating as the primary transmission reception point, and the instructions are further executable by the processor to cause the apparatus to:
switch from communicating with the network entity via the transmission reception point while the transmission reception point is operating as the additional transmission reception point to communicating with the network entity via the transmission reception point while the transmission reception point is operating as the primary transmission reception point based at least in part on applying the first configuration.

15. The apparatus of claim 1, wherein the instructions to receive the first control information are executable by the processor to cause the apparatus to:
receive radio resource control signaling that comprises the first control information.

16. The apparatus of claim 1, wherein the instructions to receive the second control information are executable by the processor to cause the apparatus to:
receive layer 1 signaling or layer 2 signaling that comprises the second control information.

17. An apparatus for wireless communication, comprising:
a processor;
memory coupled with the processor; and
instructions stored in the memory and executable by the processor to cause the apparatus to:
transmit first control information indicative of an information element that includes a set of inter-cell mobility parameters for communication between a user equipment (UE) and a set of transmission reception points;
transmit second control information indicative of a change in operating status of a transmission reception point of the set of transmission reception points, wherein the change in the operating status of the transmission reception point transitions the transmission reception point to one of a primary transmission reception point or an additional transmission reception point as supported by a corresponding inter-cell mobility parameter of the set of inter-cell mobility parameters; and
communicate with the UE via the transmission reception point in accordance with the change in operating status.

18. The apparatus of claim 17, wherein the instructions are further executable by the processor to cause the apparatus to:
transmit additional control information indicative of the set of transmission reception points to which the set of inter-cell mobility parameters is applicable.

19. The apparatus of claim 17, wherein the instructions are further executable by the processor to cause the apparatus to:
transmit additional control information indicative of one or more transmission reception points of the set of transmission reception points to which the set of inter-cell mobility parameters is no longer applicable.

20. The apparatus of claim 19, wherein:
the additional control information comprises a set of bits, each bit of the set of bits corresponds to a respective transmission reception point of a plurality of transmission reception points included in a serving cell of a network entity; and
a logic value of the each bit of the set of bits is indicative of whether the set of inter-cell mobility parameters is no longer applicable to the respective transmission reception point.

21. The apparatus of claim 19, wherein:
the additional control information comprises a set of bits, each bit of the set of bits corresponds to a respective transmission reception point of the set of transmission reception points; and
a logic value of the each bit of the set of bits is indicative of whether the set of inter-cell mobility parameters is no longer applicable to the respective transmission reception point.

22. The apparatus of claim 17, wherein the instructions are further executable by the processor to cause the apparatus to:
communicate, prior to transmitting the second control information, with the UE via the transmission reception point, wherein the transmission reception point is operating, prior to transmitting the second control information, as the additional transmission reception point.

23. The apparatus of claim 22, wherein the corresponding inter-cell mobility parameter comprises only a first configuration for the transmission reception point to communicate with the UE while operating as the primary transmission reception point or both the first configuration and a second configuration for the transmission reception point to communicate with the UE while operating as the primary transmission reception point or as the additional transmission reception point, respectively.

24. The apparatus of claim 17, wherein the instructions are further executable by the processor to cause the apparatus to:
communicate, prior to transmitting the second control information, with the UE via the transmission reception point, wherein the transmission reception point is operating, prior to transmitting the second control information, as the primary transmission reception point.

25. A method for wireless communication at a user equipment (UE), comprising:
receiving first control information indicative of an information element that includes a set of inter-cell mobility parameters for communication between the UE and a set of transmission reception points;
receiving second control information indicative of a change in operating status of a transmission reception point of the set of transmission reception points, wherein the change in the operating status of the transmission reception point transitions the transmission reception point to one of a primary transmission reception point or an additional transmission reception point as supported by a corresponding inter-cell mobility parameter of the set of inter-cell mobility parameters; and
communicating with a network entity via the transmission reception point in accordance with the change in operating status.

26. The method of claim 25, further comprising:
receiving additional control information indicative of the set of transmission reception points to which the set of inter-cell mobility parameters is applicable.

27. The method of claim 25, further comprising:
receiving additional control information indicative of one or more transmission reception points of the set of transmission reception points to which the set of inter-cell mobility parameters is no longer applicable.

28. A method for wireless communication at a network entity, comprising:
transmitting first control information indicative of an information element that includes a set of inter-cell mobility parameters for communication between a user equipment (UE) and a set of transmission reception points;
transmitting second control information indicative of a change in operating status of a transmission reception point of the set of transmission reception points, wherein the change in the operating status of the transmission reception point transitions the transmission reception point to one of a primary transmission reception point or an additional transmission reception point as supported by a corresponding inter-cell mobility parameter of the set of inter-cell mobility parameters; and
communicating with the UE via the transmission reception point in accordance with the change in operating status.

29. The method of claim 28, further comprising:
transmitting additional control information indicative of the set of transmission reception points to which the set of inter-cell mobility parameters is applicable.

30. The method of claim 28, further comprising:
transmitting additional control information indicative of one or more transmission reception points of the set of transmission reception points to which the set of inter-cell mobility parameters is no longer applicable.
